(19) United States
(12) Patent Application Publication
(10) Pub. No.: US 2024/0020965 A1
(43) Pub. Date: Jan. 18, 2024

(54) METHOD AND SYSTEM FOR MANAGING TREATMENT OF A CROP EMPLOYING LOCALISED PEST PHENOLOGY INFORMATION

(71) Applicant: SEMIOSBIO TECHNOLOGIES INC., Vancouver (CA)

(72) Inventors: Sophie Louise JOHNS, Vancouver (CA); Andrew Jordan Frewin, Cambridge (CA); Jordan Richard Hazell, Dunnville (CA); Michael Walter Gilbert, Vancouver (CA)

(21) Appl. No.: 18/034,516

(22) PCT Filed: Oct. 28, 2021
(86) PCT No.: PCT/CA2021/051527

§ 371 Date: Apr. 28, 2023

(30) Foreign Application Priority Data
Oct. 29, 2020 (CA) 3097615

(51) Int. Cl. G06V 20/00; G06Q 50/02

(52) U.S. Cl. CPC G06V 20/00; G06Q 50/02

(57) ABSTRACT

The application provides a method, system and device for managing pest treatment and crop growth based on pheno logical model, the system comprising one or more network-interfacing sensors configured to acquire and communicate sensed data associated with the one or more crop locations, a digital data storage component for storing, over time, in association with the one or more crop locations, the sensed data, pest treatment application data, crop outcome data, and the pheno logical model for the one or more crop locations that provides pest treatment application suggestions in connection with the sensed data, and a digital data processor in network communication with the digital data storage component and operable to calculate a correlation between said crop outcome data and the pest treatment application data for the one or more crop locations.

### RELATED APPLICATION

The instant application is related to and claims benefit of priority to Canadian Patent Application serial number 3,097,615, entitled “METHOD AND SYSTEM FOR MANAGING TREATMENT OF A CROP EMPLOYING LOCALISED PEST PHENOLOGY INFORMATION”, filed Oct. 29, 2020, the disclosure of which is herein fully incorporated by reference.

### FIELD OF THE DISCLOSURE

The present disclosure relates to agricultural practices, and, in particular, to a method for managing pest treatment, and a pest management system employing same.

### BACKGROUND

Various crop management models exist for characterising or predicting a crop yield. For instance, United States Patent Application No. 2016/0,247,082 entitled “Crop Model and Prediction Analytics System”, published Aug. 25, 2016 to Stehling and Fasano, discloses a model for forecasting a crop yield to inform crop management decisions based on environmental data. Similarly, U.S. Pat. No. 9,563,848 entitled “Weighted multi-year yield analysis for prescription mapping in site-specific variable rate applications in precision agriculture”, issued Feb. 7, 2017 to Hunt, discloses a method of analysing historical crop yield data according to a weighting function to generate a prescription map for crop treatment.

With respect to herbicide treatment of crops for harmful organisms such as weeds, United States Patent Application No. 2019/0,191,617 entitled “Method for Pest control”, published Jun. 27, 2019 to Hoffmann, et al., discloses a method of controlling weeds in specific subareas of digitally generated distribution map. Similarly, United States Patent Application No. 2019/0,174,739 entitled “Control of harmful organisms on the basis of the prediction of infestation risks”, published Jun. 13, 2019 to Peters, Hoffman, and Epke, discloses a method of predicting an infestation risk for a spatially bounded crop area based on historical pest activity and present weather information.

Various methodologies further disclose crop management practices for mitigating damage to crops caused by insects. For instance, U.S. Pat. No. 6,766,251 entitled “Method for pest management using pest identification sensors and network accessible database”, issued Jul. 20, 2004 to Mafra-Neto and Coler, discloses a method of identifying pests present across multiple cooperating sites for reporting purposes. Similarly, International Patent Application No. 2017/222,722 entitled “Pest occurrence risk assessment and prediction in neighboring fields, crops and soils using crowd-sourced occurrence data”, published Dec. 28, 2017 to Wiles and Balsley, employs crowd-sourced pest data to assess the risk posed to crops by insects.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a method and system for managing pest treatment of a crop, and a pest management system employing same that overcome some of the drawbacks of known techniques, or at least, provides a useful alternative thereto. Some aspects of this disclosure provide examples of such systems and methods.

In accordance with one aspect, there is provided a pest management system for managing application of pest treatment materials to one or more crop locations based on a phenological model, the system comprising one or more network-interfacing sensors configured to acquire and communicate sensed data associated with the one or more crop locations, a digital data storage component for storing, over time, in association with the one or more crop locations, the sensed data, pest treatment application data, crop outcome data, and the phenological model for the one or more crop locations that provides pest treatment application suggestions in connection with the sensed data, and a digital data processor in network communication with the digital data storage component and operable to calculate a correlation between said crop outcome data and the pest treatment application data for the one or more crop locations. In some embodiments, the correlation between the crop outcome data and the pest treatment application data is calculated in view of the pest treatment application suggestions provided by the phenological model.

In some embodiments, the one or more crop locations comprise the location of one or more of a farm, a field, a crop area, a portion of a field, a block, a portion of a block, a row of plants, a portion of a row of plants, a group of plants, a plant, and a portion of a plant.

In some embodiments, the digital data processor is further configured to modify the pest treatment application suggestions in the phenological model for at least some of the one or more crop locations based on the correlation.

In some embodiments, the digital data processor is further configured to modify the phenological model by replacing at least some of the pest treatment application suggestions for at least some of the one or more crop locations.

In some embodiments, at least some of the sensed data comprises at least one of environmental data, insect monitoring data, a crop stage, and observational data.

In some embodiments, at least some of the crop outcome data comprises observational crop data.

In some embodiments, the observational crop data comprises at least one of pre-harvest crop data and post-harvest crop data.

In some embodiments, at least some of the crop outcome data relates to at least one of a yield, a grade, and a crop damage.

In some embodiments, at least some of the crop outcome data comprises sensed crop data.

In some embodiments, at least some of the crop outcome data is indicative of crop value.

In some embodiments, the system further comprises one or more pest treatment deployment devices configured to apply the pest treatment materials in response to a control signal generated in response to the pest treatment application suggestions.

In some embodiments, the one or more pest treatment deployment devices are

further configured to selectively apply the pest treatment materials at specific locations of the one or more crop locations in response to the control signal.

In some embodiments, the pest treatment deployment devices are configured to release the pest management materials from one of a material distribution conduit, a distributed material reservoir, a vehicle-based material distributor, and a combination thereof.

In some embodiments, the digital data storage component stores pest treatment material data in association with each of the pest treatment application data, the pest treatment material data comprising at least one of a volume, a type, or a concentration of the pest treatment materials.

In some embodiments, the digital data processor is further operable to determine a value correlation between the crop outcome data and the pest treatment material data for each of the one or more crop locations.

In accordance with another aspect, there is provided a pest management method for managing the application of pest management materials to one or more crop locations based on a phenological model stored on a digital data storage component and comprising pest treatment application suggestions in association with sensed data, the method comprising: acquiring, by one or more network-interfacing sensors, sensed data associated with the one or more crop locations; communicating the sensed data to the digital data storage component; storing on the digital data storage component, over time and in association with the one or more crop locations, the sensed data, pest treatment application data, and crop outcome data; calculating, via a digital data processor in network communication with the digital data storage component, a correlation between the crop outcome data and the pest treatment application data in association with the one or more crop locations. In some embodiments, the correlation between the crop outcome data and the pest treatment application data is calculated in view of the pest treatment application suggestions of the phenological model.

In some embodiments, the one or more crop locations comprise the location of one or more of a farm, a field, a crop area, a portion of a field, a block, a portion of a block, a row of plants, a portion of a row of plants, a group of plants, a plant, and a portion of a plant.

In some embodiments, the method further comprises modifying the phenological model by adjusting the pest treatment application suggestions based on the correlation.

In some embodiments, the method further comprises modifying the phenological model by replacing at least some of the pest treatment application suggestions with corresponding modified pest treatment application suggestions.

In some embodiments, the acquiring sensed data associated with the one or more crop locations comprises acquiring at least one of environmental data, insect monitoring data, a crop stage, and observational data.

In some embodiments, at least some of the crop outcome data comprises observational crop data.

In some embodiments, at least some of the observational data comprises at least one of pre-harvest crop data and post-harvest crop data.

In some embodiments, at least some of the crop outcome data comprises relates to at least one of a yield, a grade, and a crop damage.

In some embodiments, at least some of the crop outcome data is indicative of crop value.

In some embodiments, the method further comprises generating a control signal

in response to the pest treatment application suggestions and, upon receipt of the control signal, applying via one or more pest treatment deployment devices the pest treatment materials.

In some embodiments, the applying comprises selectively applying the pest treatment materials at specific locations of the one or more crop locations in response to said control signal.

In some embodiments, the applying comprises releasing the pest management materials from one of a material distribution conduit, a distributed material reservoir, a vehicle-based material distributor, and a combination thereof.

In some embodiments, the method further comprises storing pest treatment

material data in association with each of the pest treatment application time, wherein the pest treatment material data comprises at least one of a volume, a type, or a concentration of the pest treatment materials.

In some embodiments, the method further comprises calculating a value correlation between the crop outcome data and the pest treatment material data for each of the one or more crop locations.

In accordance with another aspect, there is provided a pest management device for managing the application of pest management materials to one or more crop locations based on a phenological model, the system comprising: a network communications bus for accessing one or more network-interfacing sensors configured to acquire and communicate sensed data associated with the one more crop locations; a data storage component for storing, over time and in association with the one or more crop locations the sensed data, pest treatment application data, crop outcome data, and the phenological model providing pest treatment application suggestions in connection with the sensed data; and a digital data processor in network communication with the digital data storage component and operable to calculate a correlation between the crop outcome data and pest treatment application data for the one or more crop locations. In some embodiments, the correlation between the crop outcome data and the pest treatment application data is calculated in view of the pest treatment application suggestions provided by the phenological model.

In some embodiments, the one or more crop locations comprise the location of one or more of a farm, a field, a crop area, a portion of a field, a block, a portion of a block, a row of plants, a portion of a row of plants, a group of plants, a plant, and a portion of a plant.

In some embodiments, the digital data processor is further configured to modify the pest treatment application suggestions in the phenological model for at least some of the one or more crop locations based on the correlation.

In some embodiments, the digital data processor is further configured to modify the phenological model by replacing at least some of the pest treatment application suggestions with corresponding modified pest treatment application suggestions for at least some of the one or more crop locations.

In some embodiments, at least some of the sensed data comprises at least one of environmental data, insect monitoring data, a crop stage, and observational data.

In some embodiments, at least some of the crop outcome data comprises observational crop data.

In some embodiments, the observational crop data comprises at least one of pre-harvest crop data and post-harvest crop data.

In some embodiments, at least some of said crop outcome data relates to at least one of a yield, a grade, and a crop damage.

In some embodiments, at least some of said crop outcome data comprises sensed crop data.

In some embodiments, at least some of said crop outcome data is indicative of crop value.

In some embodiments, the network communications bus is further operable to

communicate with one or more pest treatment deployment devices configured to apply the pest treatment materials in response to a control signal generated in response to the pest treatment application suggestions.

In some embodiments, the network communications bus is further operable to communicate with the one or more pest treatment deployment devices so to selectively apply the pest treatment materials at specific locations of the one or more crop locations in response to said control signal.

In some embodiments, the digital data storage component stores pest treatment material data in association with each of the pest treatment application data, the pest treatment material data comprising at least one of a volume, a type, or a concentration of the pest treatment materials.

In some embodiments, the digital data processor is further operable to determine a value correlation between the crop outcome data and the pest treatment material data for each of the one or more crop locations.

In accordance with another aspect, there is provided a crop growth management system for managing application of crop treatment materials to one or more crop locations based on a phenological model, the system comprising: one or more network-interfacing sensors configured to acquire and communicate sensed data associated with the one or more crop locations; a digital data storage component for storing, over time and in association with the one or more crop locations, the sensed data, crop treatment application data, crop outcome data related to a crop value, and the phenological model providing crop treatment application suggestions for the crop treatment material in connection with the sensed data; and a digital data processor in network communication with the digital data storage component and operable to calculate a correlation between the crop outcome data and the crop treatment application data for the one or more crop locations. In some embodiments, the correlation between the crop outcome data and the crop treatment application data is calculated in view of the crop treatment application suggestions provided by the phenological model.

In some embodiments, the one or more crop locations comprise the location of one or more of a farm, a field, a crop area, a portion of a field, a block, a portion of a block, a row of plants, a portion of a row of plants, a group of plants, a plant, and a portion of a plant.

In some embodiments, the digital data processor is further configured to modify he crop treatment application suggestions in the phenological model for at least some of the one or more crop locations based on said correlation.

In some embodiments, the digital data processor is further configured to modify the phenological model by replacing at least some of the crop treatment application suggestions with corresponding modified crop treatment application suggestions for at least some of the one or more crop locations.

In some embodiments, at least some of the sensed data comprises at least one of environmental data, insect monitoring data, a crop stage, crop nutrient data, soil moisture data, and observational data.

In some embodiments, at least some of the crop outcome data comprises observational crop data.

In some embodiments, the observational crop data comprises at least one of pre-harvest crop data and post-harvest crop data.

In some embodiments, at least some of the crop outcome data relates to at least one of a yield, a grade, and a crop damage.

In some embodiments, at least some of the crop outcome data comprises sensed crop data.

In some embodiments, at least some of the crop outcome data is indicative a net value of a crop.

In some embodiments, the system further comprises one or more crop treatment deployment devices operable configured to apply the crop treatment materials in response to a control signal generated in response to the crop treatment application suggestions.

In some embodiments, the one or more crop treatment deployment devices are further configured to selectively apply the crop treatment materials at specific locations of the one or more crop locations in response to said control signal.

In some embodiments, the crop treatment deployment devices are configured to release the crop treatment materials from one of a material distribution conduit, a distributed material reservoir, a vehicle-based material distributor, and a combination thereof.

In some embodiments, the digital data storage component stores crop treatment material data in association with each of the pest treatment application data, the pest treatment material data comprising at least one of a volume, a type, or a concentration of the pest treatment materials.

In some embodiments, the digital data processor is further operable to determine a value correlation between the crop outcome data and the crop treatment material data for each of the one or more crop locations.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is an illustrative plot of predicted and actual pest trap data for two years of data acquisition, in accordance with various embodiments;

FIG. 2 is an illustrative plot of daily trap capture data, in accordance with various embodiments;

FIG. 3 is an illustrative plot of the difference in observed trap capture data from generalised and location-specific phenological models, in accordance with various embodiments;

FIG. 4 is an illustrative plot of trap capture data for various crop locations, in accordance with various embodiments;

FIG. 5 is a schematic diagram of forty crop locations having respective illustrative plots of expected and observed trap capture profiles, in accordance with various embodiments;

FIG. 6A is an illustrative plot of expected pest flight profiles and associated pest treatment time window recommendations, and FIG. 6B is an illustrative plot of flight profiles based on location-specific sensed data and associated pest treatment time window recommendations, in accordance with various embodiments;

FIGS. 7A and 7B are illustrative plots of pest flight profiles as a function of degree days and calendar days, respectfully, overlaid with pest treatment time window recommendations, in accordance with various embodiments;

FIGS. 8A and 8B are illustrative plots of pest trap capture data for two calendar years fit with different phenological models, in accordance with various embodiments;

FIG. 9A is an illustrative plot of pest flight profiles and corresponding pest hatching profiles, and FIG. 9B is an illustrative plot of pest flight profiles overlaid with pest treatment applications, in accordance with various embodiments;

FIG. 10 is a diagram of a process for managing pest treatment applications, in accordance with various embodiments;

FIG. 11 is a diagram of a process for informing pest management practices based on predictive phenological models in view of various data sources, in accordance with various embodiments;

FIG. 12 is a diagram showing data collection and the provision of farm-specific pest treatment suggestions, in accordance with various embodiments;

FIG. 13 is a diagram of a process for providing pest management suggestions based on a pest model and various data sources, in accordance with various embodiments;

FIG. 14 is a diagram of a process for providing ROI-informed pest

management intervention suggestions, in accordance with various embodiments;

FIGS. 15A to 15C are illustrative plots showing data collection of a real-time pest risk analysis system, in accordance with various embodiments;

FIGS. 16A and 16B are illustrative plots of flight profiles based on location-specific sensed data and associated pest treatment times and pest treatment time window recommendations, in accordance with various embodiments;

FIG. 17 is a diagrammatic representation of location-specific pest data acquisition results in, accordance with various embodiments; and

FIG. 18 is an illustrative flowchart of records management activities associated with crop treatment activities, in accordance with various embodiments.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The term “comprising”, as used herein, will be understood to mean that the list following is non-exhaustive and may or may not include any other additional suitable items, for example one or more further feature(s), component(s) and/or element(s) as appropriate.

The term “crop”, as used herein, will be understood to mean any one or more plants or organisms that may be harvested. A crop may, for instance, be aesthetic in nature, or may be one that is grown for personal consumption, or harvested for commercial sale. A crop may comprise a single organism (e.g. a bush, a tree, a plant, a vine, a mushroom, or the like), a group of organisms (a row of crops in a farm field, a cluster of trees, or the like), a crop plot, a farm, or the like. Accordingly, a “crop location” may refer to a highly specific location, such as that corresponding to a particular plant, or portion thereof (e.g. a South-facing bough of a tree, a grouping thereof, a particular vine in a row of vines, a tree canopy, or the like). A crop location may alternatively, or additionally, correspond to a row of crops, a field, a particular acreage of a farm, a crop within a particular area, geographic location, or feature (e.g. a flat plot of land, a slope, such as a South-facing slope, a valley, a ravine, a mesa, a hillside, a plot of land characterised by a particular nutrient or requirement level, such as a riverside plot, or the like), or, a crop location may refer to larger swaths of land, such as a farm, a cluster thereof, a region sharing a common aquifer, or the like. Further, a crop may refer to a single species of organism (e.g. a carrot, a Brazil nut tree, a particular species of grape or barley, or the like), or may comprise or encompass more than one crop species.

Accordingly, and in accordance with various embodiments, a location-specific sensor may comprise one that is operable to measure, either directly or indirectly, a metric associated with a crop and/or crop location in real- or near-real time, at periodic or otherwise determined intervals, integrated over a designated time span, or the like. A sensor may be associated with a specific plant, or portion thereof, or may represent a larger scale of crop (e.g. representative of many or all crop locations on a farm). Further, a location-specific sensor may correspond not to a particular plant, but to a crop area, or crop plot, in general. For instance, an insect trap camera sensor attached to a branch of a tree may report insect population size and phenological stage for a localised infestation in said tree; or, in some embodiments, its measurement may be an indication of an insect population across a more global parameter for nearby crops. In other embodiments, a soil moisture sensor embedded in soil near a plant may report measurement of a soil moisture or amount of water available to a specific plant; or, in some embodiments, its measurement may represent a more global parameter for nearby crops. Additionally, or alternatively, a wind sensor on a hillside situated alongside, adjacent, or nearby (e.g. on a hillside just south) of a farm may be associated with certain associated portions of the farm (e.g. the southern crop rows of the farm).

In some embodiments, a sensor may be network-interfacing, or otherwise operable to communicate in a wired or wireless fashion with other sensors, or to a digital application, such as a digital pest management platform. In some embodiments, a sensor may be directly or indirectly coupled with one or more pest management deployment devices platform so to trigger treatment of a crop upon registering a designated measurement. Further, a sensor may comprise a network of sensors that independently or collectively contribute to providing a crop metric or a plurality thereof. Examples of location-specific sensors may include, but are not limited to, thermometers, pressure sensors, humidity sensors, leaf wetness sensors, adsorption or absorption-based sensors, irradiation meters, chemical sensors, wind speed sensors, pest traps, cumulative flight sensors, electrical conductivity sensors, soil moisture sensors, dendrometers, hygrometers, pH meters, salinity meters, or the like.

The term “pest”, as used herein, will be understood to refer to an organism that may be harmful to a crop, crop quality, or a crop yield, or may in any way compete with a crop and in so doing cause destruction, promote any other unwanted crop outcome, or suppress a desired crop outcome. For instance, a pest may comprise a weed or other plant organism that may consume crop resources or be otherwise harmful to a crop. In accordance with some embodiments, a pest may comprise a vertebrate, such as, but not limited to, a mouse, mole, vole, or squirrel. In accordance with some embodiments, a pest may comprise an insect, such as a moth or beetle, that may directly or indirectly harm a crop, reduce a quality or yield thereof, or the like. In accordance with some embodiments, a pest may comprise a fungus, bacteria, or other such pest and/or disease inducing pest, that may directly or indirectly harm a crop, reduce a quality or yield thereof, or the like. Accordingly, a pest treatment may comprise the application of a pesticide, herbicide, poison, trap system, bait system, noise or motion inducer, or fungicide, or any other treatment intended to kill, incapacitate, sterilize, scare, or otherwise reduce or discourage the presence of a pest. A pest treatment may also include a treatment that affects the behaviour of a pest, by for example, encouraging or discouraging a pest from certain behaviours. Such a treatment may include pheromones that may cause insect mating disruption or luring within, for example, a crop area. In accordance with various embodiments, a pest treatment, or pest management intervention, may comprise a specific timing of an application of a pesticide, or a prescribed schedule and/or dosage of pesticide. A pest treatment is therefore not limited to the application of a pesticide to a specific area or subregion of a crop, but may further refer to a particular application time (e.g. a calendar day, a degree day, a crop stage, a range thereof, etc.).

The term “crop outcome”, as used herein, will be understood to refer to any qualitative or quantitative sensed or observed property of a crop that may be associated, directly or indirectly, with a crop characteristic (which may or may not be impacted by pest activity or a certain crop treatment). Examples of crop outcomes may include, but are not limited to, one or more of a crop quantity (e.g. gross weight, net weight, amount of crop waste or crop loss, or the like.), a crop quality (e.g. a grade of crop product), a crop value (e.g. a dollar amount of all crop sales, of crop sales related to a particular grade of product, or the like), crop yield, or the like. The presence or absence of any characteristic of a crop that may impact its market value can be referred to as a crop outcome.

In accordance with various embodiments, a crop outcome may comprise a return on investment (ROI) in view of crop management practices. That is, a crop outcome may relate to a total sale value of a crop in comparison to the expense associated with of applying one or more crop treatments. For instance, a crop in a first location may produce a top-grade product with a sale value of $50, while also producing a lower-grade product for a sale value of $50, following a pesticide treatment regimen that cost $20 over a growing season, resulting in a crop outcome ROI of $80. A second location, subject to a lesser pest treatment regime costing $10 over a growing season, may in turn yield only $25 worth of top-grade product, while yielding $75 worth of lower grade product upon sale for a ROI of $90. Such crop outcomes, in accordance with various embodiments, may be utilised by a crop treatment management platform by including historical crop outcomes in a crop management model to improve crop management. Crops may be “graded” according to specific characteristics, which may or may not reflect market value. For example, grain grades are often determined in accordance with specific predetermined crop characteristics. In some cases, a higher-grade crop may be desirable and, therefore, a crop outcome may be the specified crop grade (e.g. Western Red Spring (CWRS) wheat is graded into Grades 1 through 4, CW Feed, and “Wheat”). In some cases, however, certain crop outcomes may relate to characteristics that are independent of pre-determined grading; for example, protein content, protein content distribution amongst a sample, or other measurable or assessable characteristic.

In some embodiments, a crop outcome may constitute ROI, or a specific ROI target. In some embodiments, a crop outcome and/or ROI may, additionally or alternatively, be associated with a specific marketability or characteristic thereof. For instance, and without limitation, a crop outcome or ROI may be related to a regulatory category or desired compliance with a regulated guideline (e.g. certified organic, export requirements, global GAP, or the like), which may be independent of a highest crop quality or crop quantity and/or yield.

In accordance with one exemplary embodiment, a network of sensors (e.g. hundreds of sensors) may be distributed across a large farm or growing area comprising many different crops, topologies, geographical features, or the like. Each sensor may be associated with a particular crop location having potentially unique location-specific characteristics (e.g. crop stage, degree days, soil type, crop type, crop distribution, levels of sunlight, wind, environmental conditions, or the like) and/or pest phenologies. A pest management platform in networked communication with the sensor network may access/store data in association with each sensor (e.g. each crop location) as a function of, for instance, time, or degree day. Based on a phenological model (or phenological models each associated with a respective crop location), the pest management platform may, in view of the sensed data at each crop location, prescribe a particular application or regimen for each respective crop location. For example, the pest management system may prescribe, for each crop location, an optimal time to apply a pesticide, which may differ between crop locations (e.g. a farmer using a smartphone application may be recommended to apply materials to Crop A on Tuesday, and to Crop B on Thursday).

Upon application of the pest treatment material at each location, application data (e.g. a time of application, a type of material, an amount or cost thereof, or the like) may be stored in association with the specific crop location for which the application was performed. As a growing season continues, relevant crop outcome data related to crop performance (e.g. Crop A showed insect damage, Crop B exhibited significant crop growth, etc.) may be entered or manually acquired by the pest management platform. Upon harvest, the platform may further receive information related to crop outcome that are desirable by the grower (or their customers), such as, but not limited to, yield, grade, value upon sale, return on investment, a desirable plant or harvest characteristic (e.g. high protein or sugar content, thick or thin skin, early or late hull-split) or the like. A digital data processor may then, on a location-by-location basis (i.e. for each of possibly hundreds of crop locations in some embodiments, including, e.g., on a plant basis or a plant/canopy strata basis), assess an effectiveness of each pest treatment application regimen (e.g. Crop A had a high ROI, Crop B had a low ROI) on the plant or plants at or associated with a given location. Based on the identification of any such correlations, the crop management platform may then adjust, for the following growing season and independently for each crop location, the model from which it bases application suggestions.

For example, if Crop A were to exhibit, through sensor data, the same conditions as the previous year (e.g. the same temperatures for the same week of the growing season), the management platform may determine that the model corresponding to Crop A should not be adjusted (due its positive ROI the year before), and may continue to suggest that grower apply materials on Tuesday. However, Crop B, also experiencing the same conditions as the previous year, may have its location-specific model adjusted (due to a poor ROI the year before), to, for instance, be more similar that of Crop A; the platform may then recommend that Crop B be treated on Wednesday, rather than Thursday, as was the recommendation the year before. This process may then be repeated across all crop locations associated with platform, with data continuously being acquired and processed for location-specific model improvement and iteration. Across hundreds to thousands of crop locations, each acquiring large amounts of data over the course of several years, many correlations may be determined and applied to different crop locations to improve pest treatment models and application suggestions arising therefrom. In some embodiments, the actual application times will also be taken into consideration in future suggestion for crop application. For example, if a first crop treatment application is suggested to be applied at some time after a pre-existing phenological model makes such a suggestion, the future suggestions in the same growing season may be impacted. While in some cases they may be delayed by the same time, the amount of time that passes between applications may, in some embodiments, lessen the impact of prior crop treatments applications or the interval therebetween.

In accordance with various embodiments, a pest behaviour may be characterised by a pest phenology. That is, a pest, such as an insect, may exhibit known, predictable, or estimatable seasonal, diurnal, or periodic behaviour in a relation to a set of conditions. Examples of conditions that may be related to pest phenology may include, but are not limited to, environmental data such as weather or climate, hosts that may be present at a site, a habitat, a latitude and/or photoperiod of a site, or the like. In some embodiments, genetics may contribute to pest phenology. For example, the developmental rate, a host suitability, and/or a diapause induction may play a role in pest phenology. In accordance with various embodiments, a pest phenology may be related to a prevalence of pests in a location over time. A non-limiting example of a characterisation of a pest phenology may comprise a pest flight season, or a time-dependent population of a pest or pests in a crop location as determined by, for instance, pest traps or observation.

Pest phenology may, in accordance with various embodiments, be characterised by a variety of models, herein referred to as a “phenological models”. For instance, a pest phenology model may comprise a degree day model (DD model), an example of which is the PETE model developed circa 1976. While such models may be useful for particular regions, such as the jurisdictions or portions thereof for which they were developed, their efficacy may not necessarily translate to all geographical areas within the region to which they apply. For example, even within such a region, different climates, soil, rainfall, shade, crops, geographical features, or the like may result in significant differences. Moreover, they constitute estimates for large regions in which the characteristic that is being modeled is not homogeneous. For instance, the PETE model developed for the state of Michigan was adjusted circa 1982 for the state of Washington by Brunner and Hoyt. Reports of poor fits resulted in a subsequent adjustment of the model for the state of Washington, where data was again acquired from 7 orchards over 4 years.

Generally, such data acquisition and analysis are costly and laborious, and may result in the acquisition of data that is not representative of a particular growing site or crop location in which it is employed. As such, so-called “generalised phenological models” of pest behaviour, also herein referred to as “commercial models” or “regional models”, may not expected to describe a total phenological variation across many crop locations, and may not be applicable across a growing region at all times or in all locations (or at all). Rather, accuracy of such model predictions may be compromised if site conditions differ from those used in model generation. For instance, crop management practices (e.g. organic farming, etc.), microclimates (e.g. proximity to a body of water, spring temperatures, or the like), seasonal aberrations or unusual events relating to meteorological events in the specified area or surrounding regions, surrounding crops or vegetation, genetic divergence of a pest species over time, or the like, may differ from site to site, leading to discrepancies between what is predicted by a generalised model and what is actually observed at a particular crop location. Furthermore, such generalised models may be representative of average conditions across a large region, and may perform poorly for a site having outlier characteristics. As such, a need exists for means of predicting pest phenology on a site- or location-specific basis, wherein, for instance, a grower may treat a crop with pesticides at an appropriate time for a particular site, rather than according to a generalised model that may be have been developed for a differently characterised region. Such location-specific pest phenology models, also herein referred to as “site-specific models”, and more generally as “phenological models”, in accordance with various embodiments, will therefore be understood to potentially be distinct from “regional”, “generalised”, or “commercial models”, depending on the evolution of a particular location-specific model. site-specific model, however, and in accordance with some embodiments, may be derived, or iteratively adapted from a generalised model. For instance, a site-specific phenological model may, in one embodiment, comprise a generalised model for a first growth season, and be adjusted based on, for instance, sensed data at a particular location, for an improved characterisation of pest phenology for a crop site in subsequent growth seasons.

The systems and methods described herein provide, in accordance with different embodiments, different examples of a pest treatment management platform in which sensed data may be used in the prescription or suggestion of a crop treatment regimen, or crop treatment application model. Various embodiments relate to the use of a crop treatment management model to prescribe, based on sensed and/or historical data, an appropriate application of, for instance, pesticides and/or chemicals to produce a desired or improved crop outcome. In some embodiments, crop outcome may be used to refine crop treatment models, or to improve an efficiency of crop management. For instance, a crop treatment model may consider a cost, either predicted or historical, associated with treating a crop (e.g. the cost of an applied pesticide), as well as a past or predicted yield of the crop, to provide, for instance, an improved return on investment. A crop treatment model may further consider location-specific sensed metrics to, for instance, prescribe different applications of a crop treatment material to different crop locations at different times, even within crops of the same type and on the same farm. A crop treatment model may, in some embodiments, further comprise climate, third-party, and/or crowd-sourced data to improve suggestions of a crop treatment material to provide a desired or improved outcome. A crop treatment model may further complement a phenological model describing pest activity for one or more sites based on, for instance, historical or sensed pest activity data.

While many embodiments described below relate to the treatment of a crop in a crop location to mitigate crop damage caused by pests, for instance through the provision of timed applications of pest treatment materials or pesticides, embodiments will be understood to not be so limited. Rather, the systems and processes described herein may relate to the application of various other materials, or various actions related to crop management that may be employed to produce a desired or improved crop outcome. For instance, the acquisition of sensed data may be included in various models relating to the use of herbicides, fertilisers, irrigation, fertigation, and the like, to provide, for instance, an improved crop ROI, without departing from the scope or spirit of the disclosure. A crop outcome may relate to the effectiveness of crop treatment applications or regimes thereof (including the suggestions or the phenological model, modified or otherwise); it may also relate to whether, and how well, a desired effect on pest control is being achieved. In some embodiments, the crop outcome may relate to year-to-year, season-to-season, or growth phase-to-growth phase improvements or degradations of pest activity or pest control efforts. Trends of any of the foregoing may constitute crop outcomes (e.g. pest reduction or healthy fruit yield improvements over time).

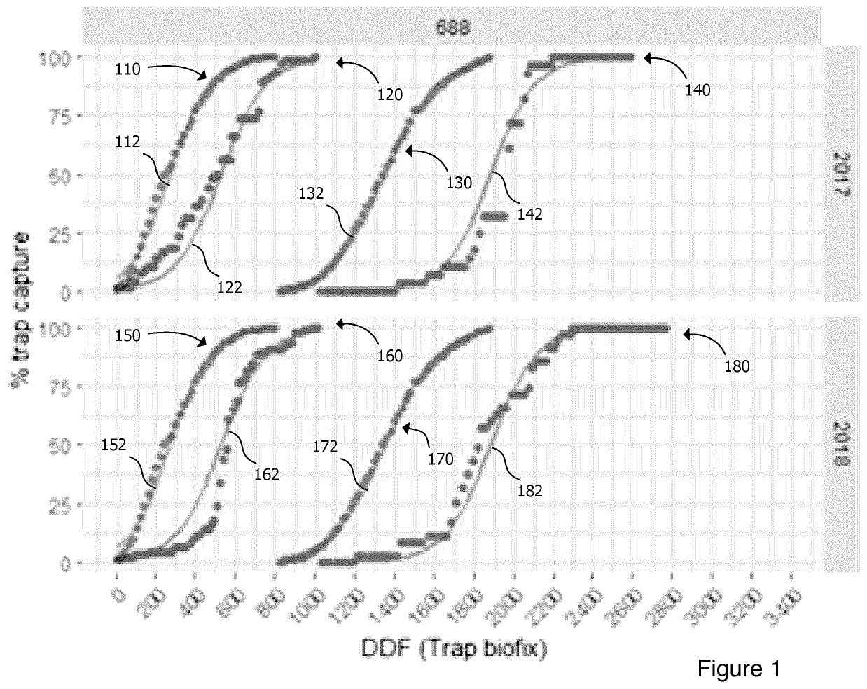

With reference to FIG. 1, and in accordance with some exemplary embodiments, plots describing exemplary phenological pest activity over two-year time windows will now be described. In this example, trap capture data showing the cumulative percentage of insects trapped as a function of degree days Fahrenheit (DDF) from a trap catch biofix (e.g. a date biofix, such as January 1^{st}, an observational biofix, etc.) are shown for two flights for each of 2017 (top panel) and 2018 (bottom panel). A regional model represented by the function 112 predicts trap counts 110 representative of a pest population at the crop location for a first flight season. Actual trap data 120 for a particular growing site, on the other hand, is fit to generate a phenological model 122 for that location for the first flight of 2017. Similar data is shown for a second flight of 2017 for the same growing site, where predicted trap data 130 is shown for the regional model 132, and actual trap data 140 is fit to generate a site-specific phenological model 142 for the second flight. Similarly, predicted trap counts 150 and 170 are shown for regional models 152 and 172 predicting a first and second pest flight, respectively, while actual trap data for first 160 and second 180 flights are fit with location-specific phenological models 162 and 182, respectively.

In this example, regional models representing pest behaviour in an average growing site for a region predict pest activity well in advance of when pests are actually observed. A grower treating crops with a pesticide according to such regional predictive models may therefore be applying crop treatments with reduced efficiency, which may result in, for instance, a reduced yield or loss of crop value upon sale. The site-level models, on the other hand, show greater predictive ability.

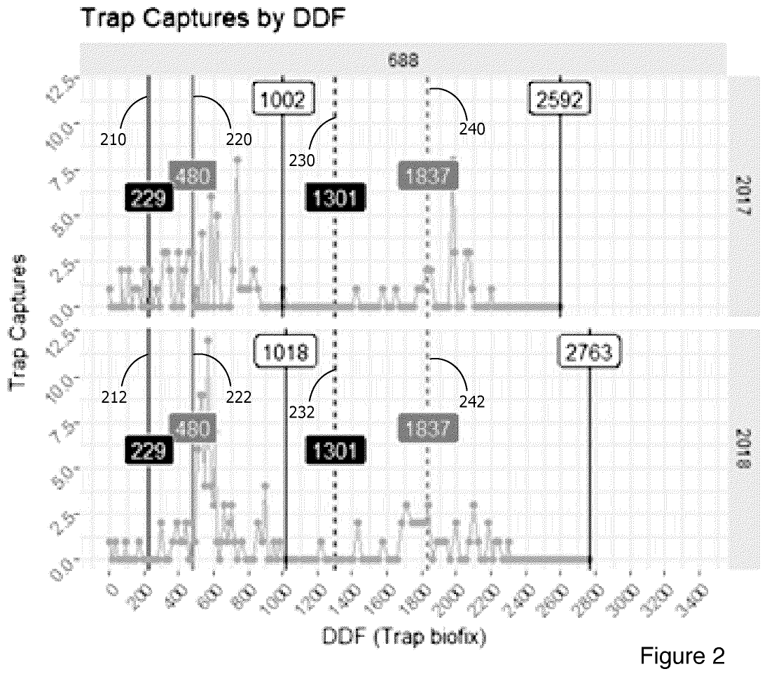

Plots in FIG. 2 show the data of FIG. 1 plotted as a of the daily number of pests trapped. Solid vertical lines 210 and 212 denote the DDF of 40% cumulative flight, an important metric for crop management related to pest hatching, as predicted by a regional model for the first flights of 2017 and 2018, respectively. Solid lines 220 and 222, on the other hand, show the DDF of 40% cumulative flight based on actual site-specific trap data for the first flights of 2017 and 2018, respectively. Similarly, dashed lines 230 and 232 show the predicted 40% cumulative flight based on regional models for the second flights of 2017 and 2018, respectively, while dashed lines 240 and 242 show the 40% cumulative flight DDF based on site-specific trap data for those respective flights. With respect to this key parameter in crop management and treatment, regional generalised models would lead a grower to apply pest treatments to a crop well before what may be considered an optimal or even effective time window for treatment, by tens of calendar days.

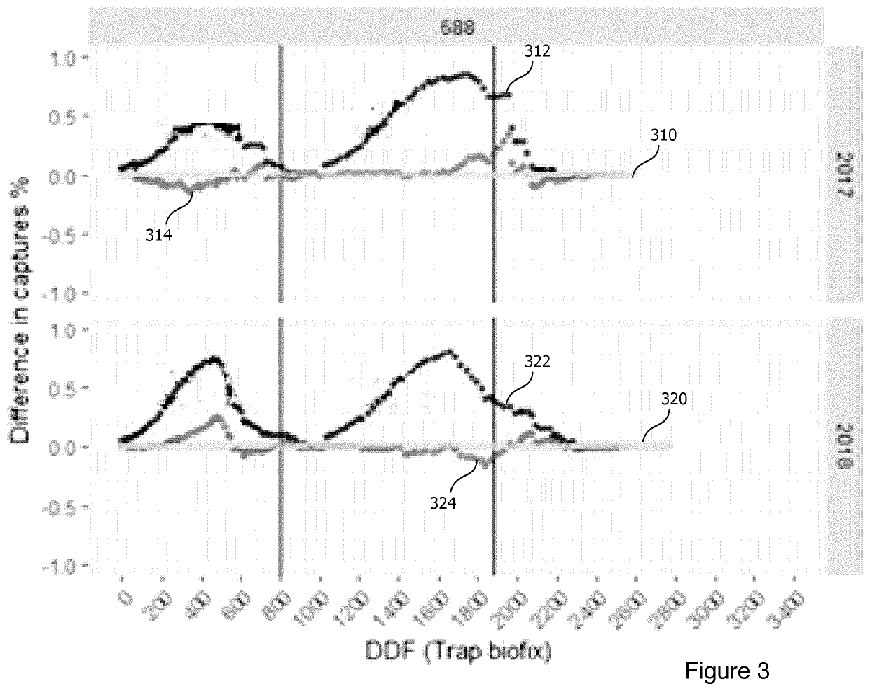

FIG. 3, in accordance with some embodiments, shows the trap data of FIG. 1, this time as a deviation from observed trap data of each model. In this example, flat lines 310 and 320 represent the actual pest capture data, which naturally shows a 0% difference from itself for all DDF. Lines 312 and 322 show the percentage of difference in capture between what was predicted based on a regional generalised model and what was actually observed in 2017 and 2018, respectively, while lines 314 and 324 show the difference between a site-specific phenological model and what was observed for 2017 and 2018, respectively. As the site-specific model showed significantly less deviation (i.e. lower absolute values of percentage difference in capture), it outperformed the conventional regional model for this particular site.

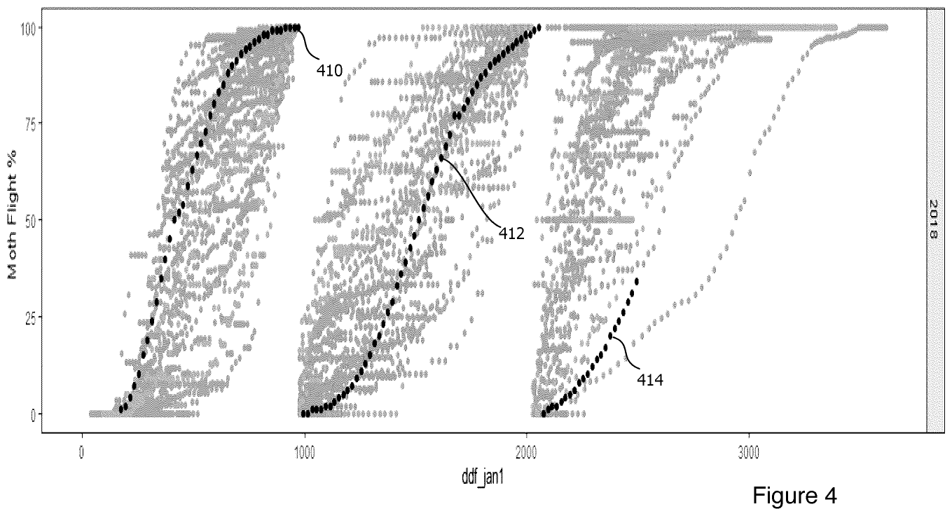

FIG. 4 shows an exemplary scatter plot of moth capture data as a function of DDF for three flights throughout a year across many different crop sites. Generalised regional models for the first, second, and third predicted flights are shown by the darkest datasets 410, 412, and 414, respectively. While such generalised model predictions may generally capture a trend of a flight in consideration of all sites, the spread in actual measured values on a site-by-site basis, as illustrated by the scattered datapoints to either side of the predictions 410, 412, and 414 for all three flights, show that many sites are not well characterised by the generalised model.

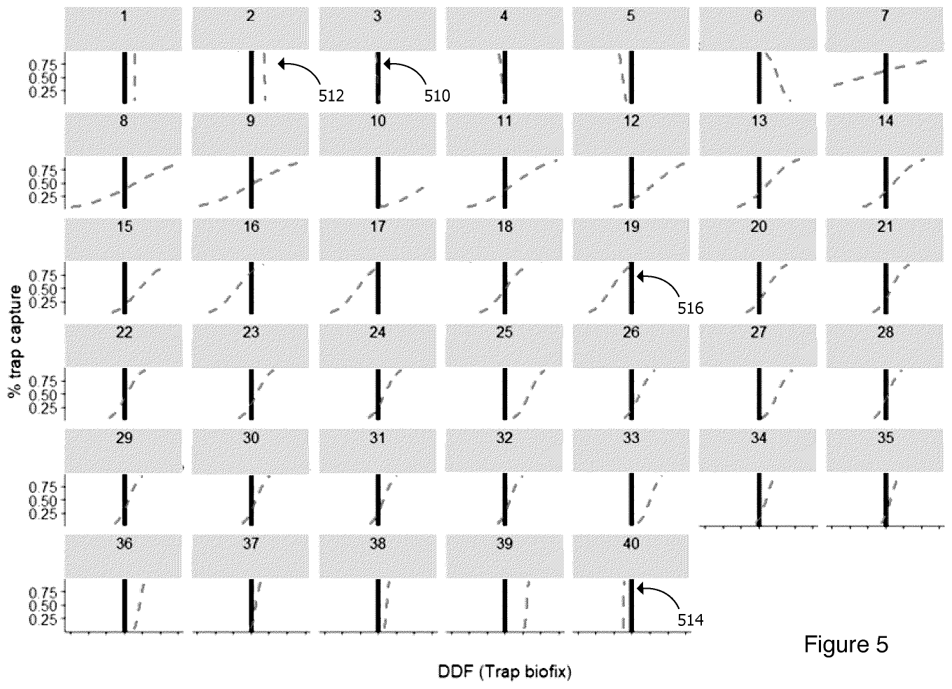

This concept is further illustrated in FIG. 5. In this case, a regional model predicting pest activity is shown as a vertical black line for each of 40 crop location sites, where each site corresponds to a respective panel labeled 1 to 40. In this exemplary embodiment, the vertical black lines correspond to the predicted population of trapped pests at each location as a function of DDF (e.g. the predicted curve 110 of FIG. 1), but scaled in x to be vertical lines to better highlight differences from actual observed pest activity at each site, shown as dashed lines. A complete overlap of a dashed and solid vertical line for a site would indicate a perfect agreement between a generalised regional model and observed pest capture. For instance, overlap 510 of site 3 shows that the regional model effectively predicted the general trend and timing of pests that would be trapped as a function of DDF at that site. On the other hand, a rightwards shift 512 of the dashed line with respect to the predicted model at site 2 indicates that while the general trend in predicted pest trapping was observed at that site, the generalised model predicted that pest activity would occur earlier than was actually observed. Conversely, the leftward shift 514 at site 40 indicates that pests were trapped (and therefore present) in advance of what was predicted by the generalised model. Pest activity curves that are neither vertical nor significantly overlapping predicted curves (e.g. the difference 516 between prediction and trap data at site 19) indicate that a generalised model neither correctly predicted the timing of a pest flight, but also failed to capture its dynamics. Many sites show a large discrepancy between predicted and actual pest activity, with a high degree of variability.

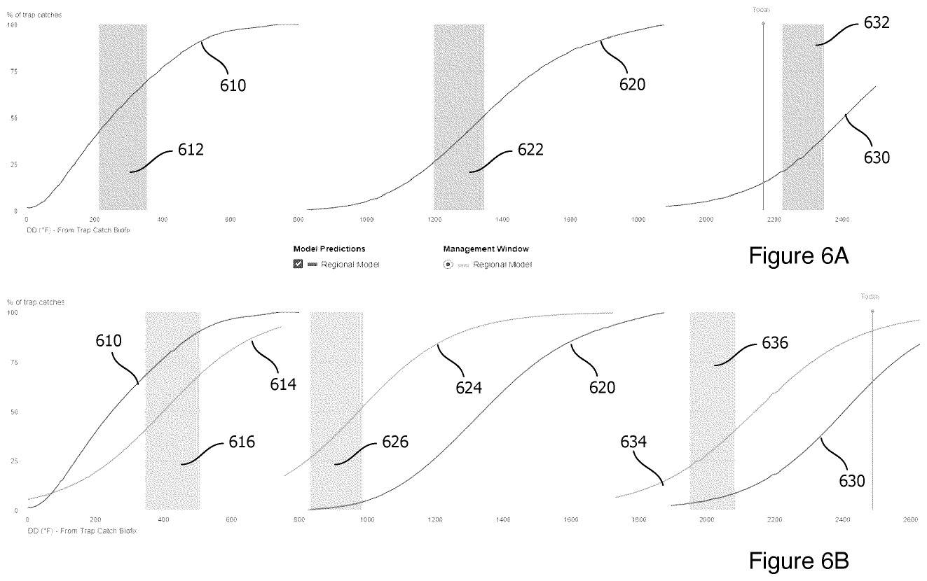

With reference to FIGS. 6A and 6B, a pest management platform for recommending improved pest treatment application times, in accordance with various embodiments, will now be described. Conventional pest treatment practices may relate to the use of regional generalised models, such as curves 610, 620, and 630, to prescribe pest treatment applications. In the example of FIG. 6A, such curves predict pest behaviour in relation to a crop for which a grower may be recommended to apply a pest treatment material during time windows 612, 622, and 632. However, as described above, such generalised models do not necessarily correspond to actual pest activity, or, for instance, a hatching period during which a grower may prefer to apply a pesticide.

In the example of FIG. 6B, a particular crop site may sense pests, for instance via one or more pest traps, according to the pest behaviour shown by curves 614, 624, and 634 corresponding to three separate flights. These curves representing actual pest behaviour are noticeably different than the overlaid prediction curves 610, 620, and 630, respectively. In this exemplary embodiment, a pest management platform may apply a phenological model that accounts for sensed pest activity, and recommend that pest treatment application(s) take place during DDF windows 616, 626, and 636, rather than generalised model windows 612, 622, and 632, respectively. In this case, the window for effective pest treatment recommended by a generalised model would scarcely overlap with the optimal window for the first flight, as sensed and modeled by curve 614, while recommended windows 622 and 632 from the regional model would entirely miss the optimal pest treatment windows for the second and third flights.

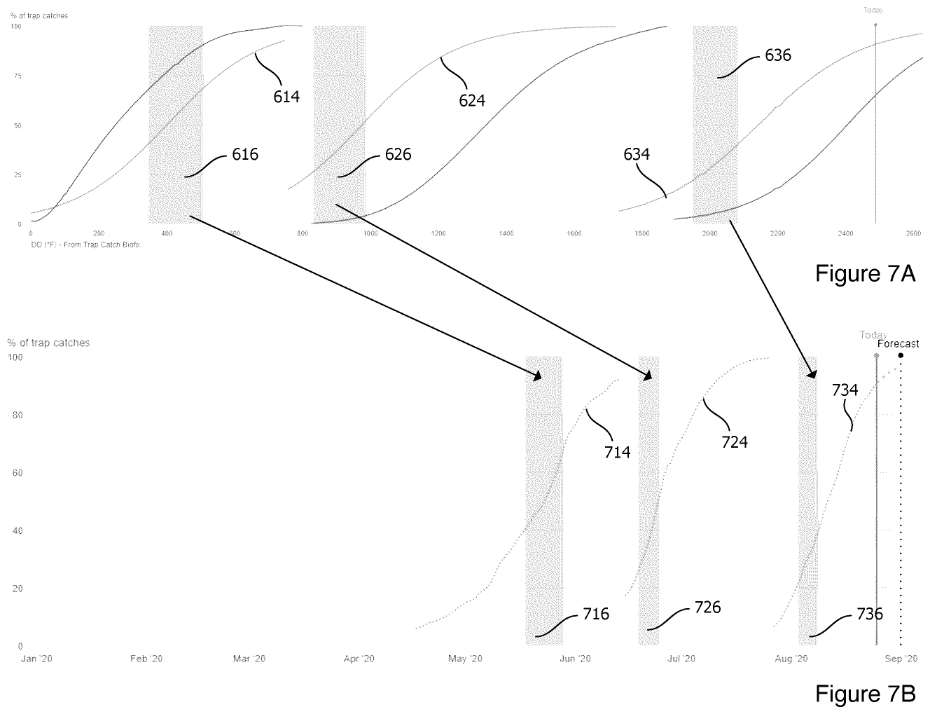

In accordance with some embodiments, pest data, such as a number of pests trapped at a particular crop location, or a model interpreting sensed data and recommending a pest treatment application, may provide recommendations in various forms or units. For instance, FIG. 7A shows sensed data and associated pest treatment application recommendations based thereon in consideration of DDF. Various embodiments relate to converting such models to, for instance, a calendar-based system, as shown in FIG. 7B. In this exemplary embodiment, site-specific phenological models 614, 624, and 634 based on DDY are converted to curves 714, 724, and 726, respectively, on a calendar-based axis for ease of use by a grower. Accordingly, pest treatment application windows 616, 626, and 636 may be reported as corresponding time windows 716, 726, and 736 on a calendar. In accordance with various embodiments, a user interface, such as a graphical user interface on a web browser or mobile phone application, may allow a user to toggle between views, units, and/or models. For instance, a grower may opt to view recommendations based on regionally sourced aggregated data and generalised models as shown in FIG. 6A, while toggling between views of calendar-based recommendations as determined from a phenological model in view of sensed data associated with a particular crop location, as shown in FIG. 7B.

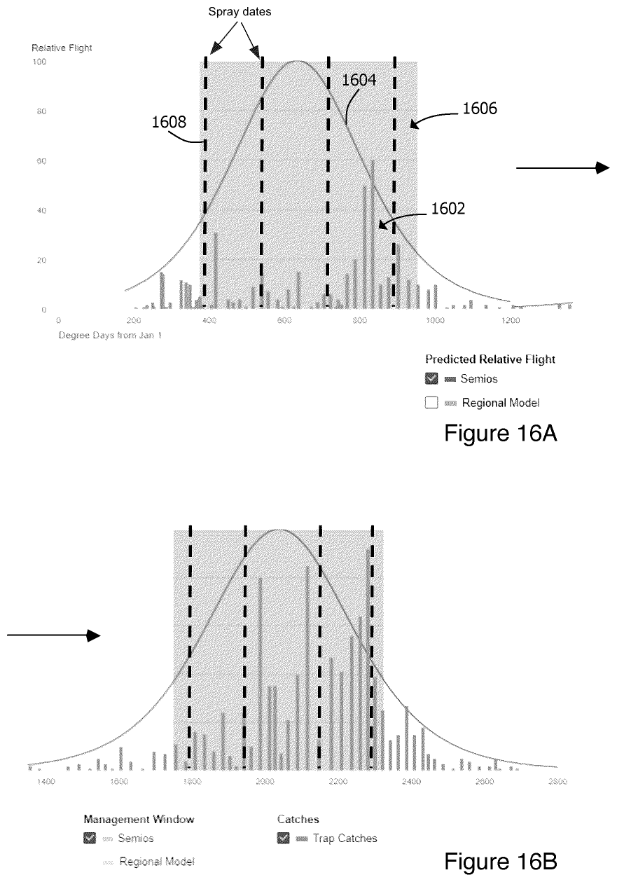

In accordance with some embodiments, FIGS. 16A and 16B show an exemplary user interface providing an alternative visual indication format from that of FIGS. 6A to 7B for showing pest activity 1602 and pest treatment application suggestions. In this example, FIGS. 16A and 16B show a plot that is continuous along the x-axis, in this case continuous in degree days since January 1. Accordingly, while FIGS. 16A and 16B show data related to two different flights within the same year, the acquisition, prediction, and recommendation data shown therein is continuous between FIGS. 16A and 16B, as schematically indicated by the arrow to the right of FIG. 16A.

In this example, pest data 1602 informs a pest phenology model of predicted relative flights 1604. This in turn may inform the determination a pest treatment management window 1606, during which time application times 1608 may be suggested and/or performed. While the data is FIGS. 6A to 7B show application time windows overlaying cumulative plots of pest and model data, the pest data 1602 as shown in FIGS. 16A and 16B is not cumulative. Similarly, the predicted relative flight model 1604 is shown similarly to a distribution of the flight. Such aspects may improve existing systems or approaches in that such presentation may be more intuitive or helpful for the crop manager, thereby improving adherence to informed application suggestions.

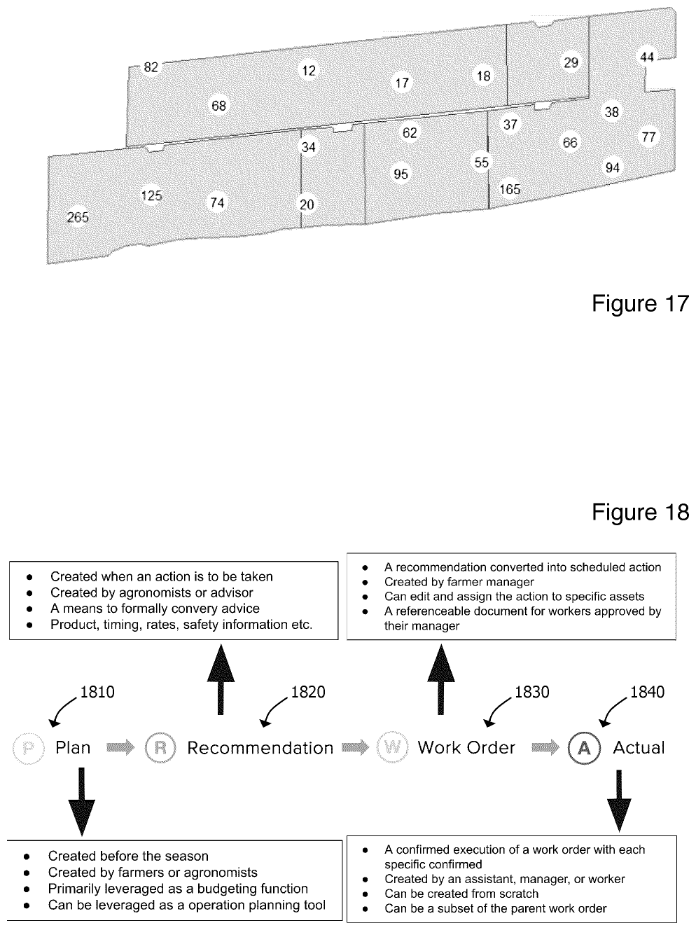

It will be appreciated that various other forms of data visualisation may be provided, in accordance with various embodiments. For example, FIG. 17 schematically illustrates an alternative format for pest reporting, which may be helpful in providing a quick or informative overview of pest activity within a growing region. In this non-limiting embodiment, a farm is visually divided into blocks, which are overlain with indicia corresponding to the number of pests that have been caught by devices geospatially located as represented by the farm map.

In accordance with various embodiments, a pest management application may obtain data from a plurality of sources. For instance, in converting a phenological model based on DDY to one based on a calendar, a pest management application may further access climate data or a weather forecast to assess future temperature data, and thus convert between a modeled DDY event, such as a hatching of insects, to calendar days that may be most effective for a pest treatment application.

In accordance with some embodiments, a particular crop location may exhibit greater similarity in pest activity between seasons than with a neighbouring crop in the same season. That is, historical pest activity at a crop location may provide a better indication of future pest activity at that location, and therefore a more accurate phenological model, than might real-time data acquired from a neighbouring crop. A phenological model for that crop location may then be based, at least in part, on previously sensed data, or a previously calculated phenological model for that location (or for a similar location). In such embodiments, a pest management application may accordingly store or otherwise access historical data related to a crop or crop location.

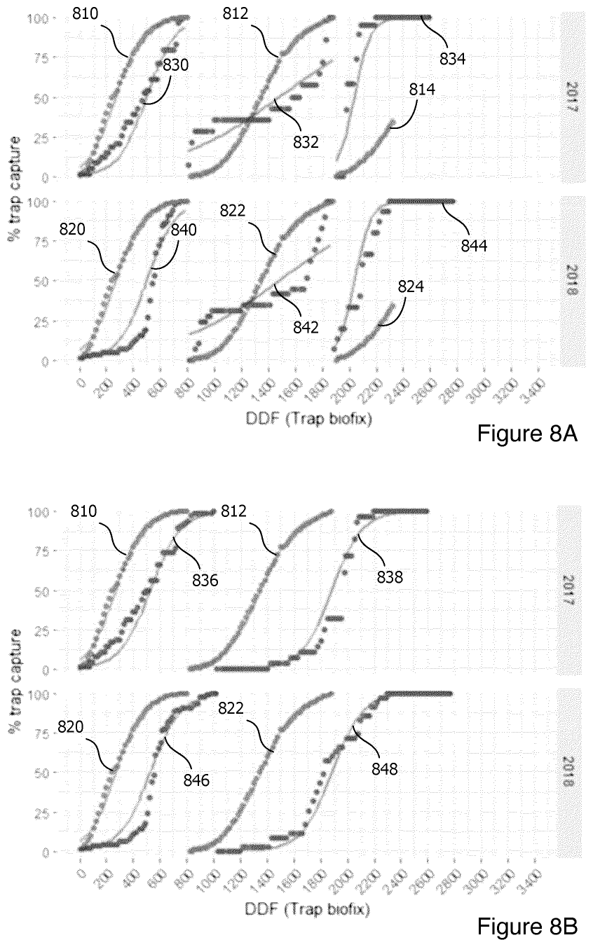

FIGS. 8A and 8B show, in accordance with one exemplary embodiment, how stored data may be accessed and processed to update a phenological model for a crop location. In this non-limiting example, data related to pest capture was acquired for the year 2017 (top panel of FIG. 8A), and again for the year 2018 (bottom panel of FIGS. 8A) in the same crop location. In this example, a generalised regional model predicted pest activity associated with three flights per year, shown by curves 810, 812, and 814 for the year 2017, and curves 820, 822, and 824 for the year 2018. Actual pest trap data for the DDF ranges corresponding to the predicted flights are shown by curves 830, 832, and 834 for the year 2017, and curves 840, 842, and 844 for the year 2018.

In FIG. 8A, phenological models based on trap data were inferred, at least in part, based on the predicted flights of the generalised regional model. However, as can be seen from the fitted model 830, the sensed data indicates that the flight generally occurred later than was expected (i.e. curve 830 is shifted to the right of curve 810). Further, the curve 830 does not appear to saturate prior to the start of the second flight corresponding to curve 832. Moreover, the curve 832 does not appear to follow what is biologically expected from a pest flight (i.e. curve 832 does not show an initial slow rise followed by rapid growth, and ending with a flatter region). Rather, one observes from the data related to curve 832 rapid growth rates at the onset and at the end of the flight, with a period of slow growth therebetween. Curve 834 also exhibits biologically incoherent properties, wherein the flight appears to already be in a rapid growth phase at the onset of the flight. This behaviour is consistent for that crop location in both 2017 and 2018.

These results indicate, in accordance with some embodiments, that flights in this particular crop location may both start later (i.e. delayed phenotypes) and last for a greater duration than predicted by the regional model. FIG. 8B shows the same predicted curves 810, 812, 820, and 822 based on a regional model. However, the phenological models fit to the same but renormalized acquired data of FIG. 8A were determined with a relaxed constraint on the start time of the flight, with an allowance of a 30% increase in generation length. As a result, phenological model fits to the data, shown by curves 836 and 838 for the year 2017 and curves 846 and 848 for the year 2018, show a significantly improved fit to the first and second flights. While the x-axis presents trap capture data as a function of DDF, the observed shift in pest treatment application recommendation for the second flight of 2017 is moved from July 16^{th} to August 6^{th}, and from July 14^{th} to August 2^{nd} in 2018 (calendar data not shown). This difference of weeks with respect to when a grower may optimally apply a pest treatment to a crop may have a significant impact on crop yield, and ultimately crop value, in accordance with various embodiments. Furthermore, and in accordance with yet other embodiments, such data may further inform future crop management decisions. For instance, a pest management application may access data related to both 2017 and 2018 to infer pest behaviour for 2019, and update a previous phenological model for site-specific pest treatment application recommendations on a localised scale.

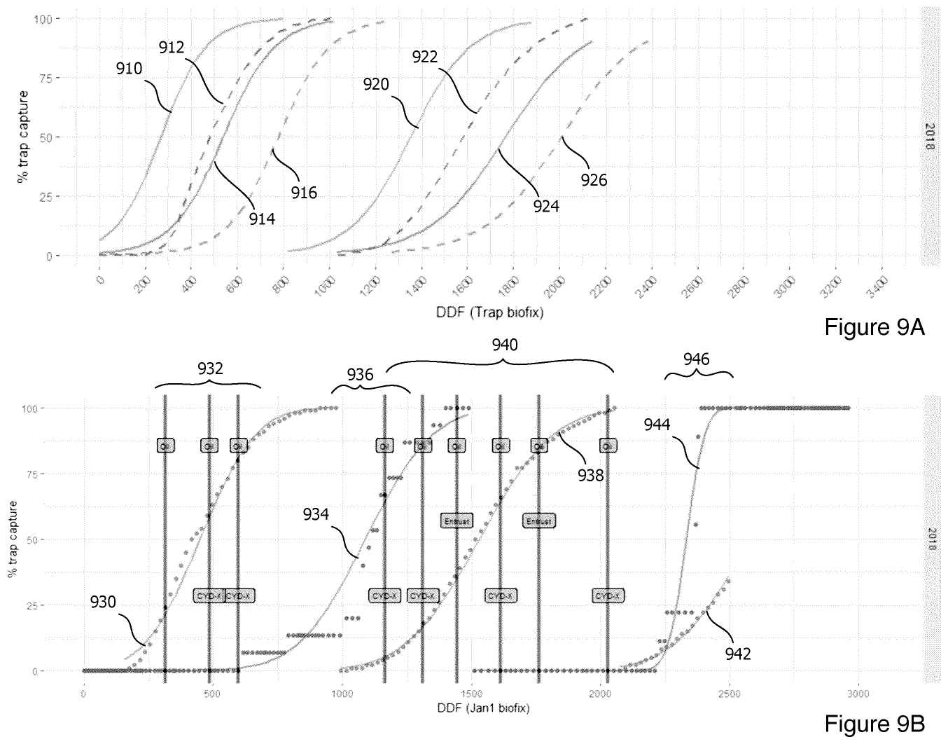

FIGS. 9A and 9B illustrate how, in accordance with some embodiments, a location-specific phenological model may provide improved crop management practices with respect to timing an application of pest treatment materials. In this exemplary embodiment, curve 910 illustrates a predicted generalised model's flight timing. Common pest treatment practices, however, target pest egg hatching, which is delayed relative to the pest flight, as illustrated by the dashed curve 912. If the generalised model prediction of flight 910 is, for instance, early compared to the actual flight shown by curve 914, application of pest treatment materials may then be inappropriately timed with an actual egg hatch, shown by dashed curve 916. These effects may be exacerbated for application of pest treatment materials upon a second flight, where the generalised model prediction 920 and corresponding predicted egg hatch 922 may be even more significantly in advance of an actual second flight 924 and corresponding actual egg hatch 926.

FIG. 9B shows an exemplary plot of predicted and actual pest data overlaid with pest treatment material application times, in accordance with various embodiments. In this example, flight data predicted by a commercially available generalised model is shown by curve 930. In this case, the grower, acting upon the recommendation of the commercial model, may apply pest treatment materials over the recommended DDF period 932, where application events are shown as vertical lines bracketed in the DDF range 932. In this example, however, actual pest data 934 shows a considerable delay (˜500 DDF) behind to the commercial model. As a result, the optimal window 936 for treating the crop with pest management materials is not properly observed, and the grower may consequently observe a large degree of pest activity and resulting crop damage. To compensate for what may erroneously be perceived as insufficient response to pests during the first flight, the grower may apply, during the second flight 938 predicted by the commercial model, additional pest treatment materials indicated by the six vertical bars during the application window 940, and may further continue to apply materials up to a third predicted flight 942. Meanwhile, the first flight 934, in actuality, has not fully run its course during this time, and the actual second flight 944, and its optimal treatment window 946, are completely missed with respect to pest treatment applications. In this example, a location-specific phenological model may significantly improve capture of actual pest activity, and provide an appropriate response thereto through improved treatment recommendation times 936 and 946. In accordance with various embodiments, such phenological modeling may not only reduce crop damage and correspondingly improve crop value, but reduce cost and labour associated with excessive pesticide usage arising from ignorance of actual pest behaviour if a grower had opted to follow a commercial model that was inappropriate for a particular crop location.

While some of the embodiments described above relate to a pest management system that utilises a location-specific phenological model to suggest pest treatment application times in connection with sensed data, various embodiments further relate to assessing a correlation between the outcome of a crop and how the crop was treated to manage pests. For instance, a grower managing several crop locations for pests may apply crop treatments materials to different crops at different times. For example, a grower may have performed crop treatment applications in windows 932 and 940 of FIG. 9B at a first crop location; then, in the days following the respective applications to the first plot, applied pest treatment materials at a second crop location. As, for instance, the timing of applications will have been different between plots, an improved crop outcome of one of the two crops may be correlated to the more optimal pest treatment schedule, in accordance with some embodiments.

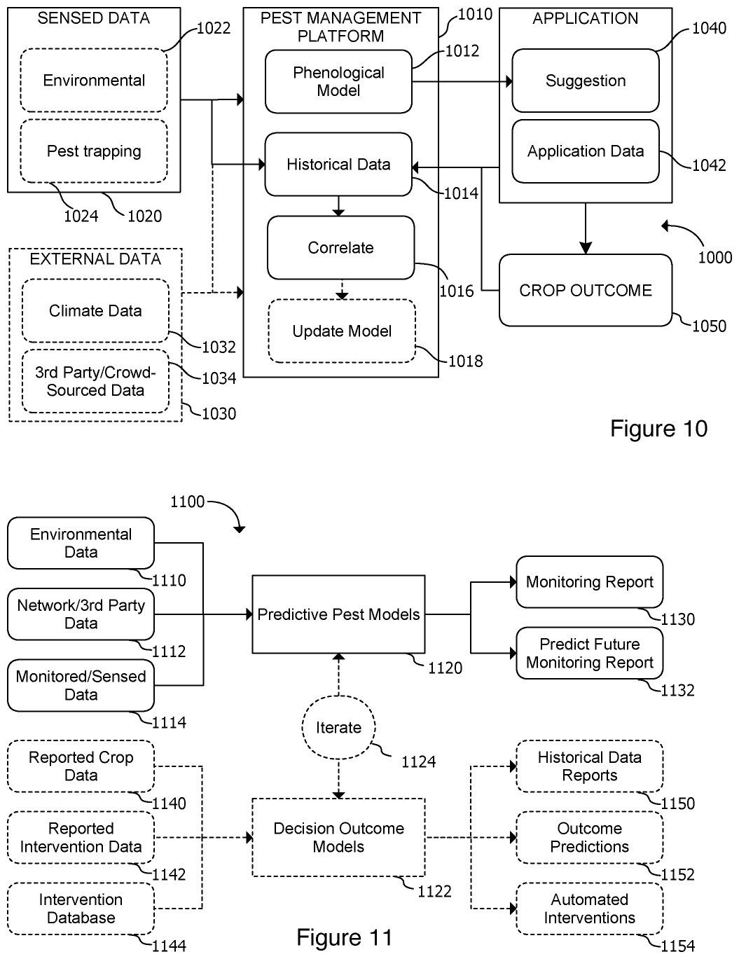

FIG. 10 schematically illustrates such an exemplary process 1000 in which, among other processes and sub-processes associated with various embodiments, a pest management application 1010 may determine a correlation between crop outcome 1050 and pest treatment application data 1042. In this non-limiting example, the pest management platform 1010 or pest management system 1010 may be in networked communication with one or more sensors configured to acquire and communicate data 1020 related to a crop location. For instance, temperature, wind, or humidity sensors, or the like, may acquire environmental data 1022 that may be associated with or otherwise used to infer or predict the initiation of a pest flight season. Alternatively, or additionally, pest trap data 1024 may be used to directly identify or quantify pest prevalence at the crop location, which may be associated with, for instance, a pest flight status. The skilled artisan will appreciate that other types of sensors may additionally or alternatively be employed to communicate relevant data 1020 to a pest management platform 1010. Furthermore, and in accordance with various embodiments, sensors may acquire data 1020 continuously, in real- or near-real-time for monitoring by the pest management platform 1010, or data may be acquired and/or communicated periodically according to a designated schedule (e.g. every ten minutes, daily, etc.). Some embodiments further relate to acquiring and integrating data 1020 over intervals (e.g. acquiring data over ten minutes and obtaining an average, or integrating over the ten-minute range for reporting).

Furthermore, and in accordance with some embodiments, a pest management platform may access external data 1030. For instance, climate or forecast data 1032 may inform the platform 1010 of impending weather conditions that may be relevant to a crop and/or pest treatment application based on a phenological model 1012. External data 1030 may additionally, or alternatively, comprise third-party or crowd-sourced data 1034 for more informed decisions related to pest management. For instance, a crop on a first farm may abut a crop location on a second farm that is reporting on pest prevalence. The pest management platform may access this third-party data 1034 from the second farm to determine, for instance, if the first crop may soon be exposed to pests. In some embodiments, external data may additionally or alternatively comprise aerial imagery data to inform crop management decisions in the context of pest treatment models.

The pest management platform 1010, having access to a stored phenological model 1012 (e.g. a commercial model, or a crop location-specific model) may, based in part on the sensed data, provide a suggestion 1040 of pest treatment material application(s). The recommendation may, in accordance with various embodiments, comprise a type of pest treatment material (e.g. a pesticide, an herbicide, a brand thereof, or the like), an amount of pest treatment material (e.g. volume), and/or a treatment schedule, such as degree day or calendar day on which to perform an application, a frequency of application, or the like. For instance, a model 1012 may prescribe, in conjunction with temperature data 1022, a designated degree day on which to apply a pesticide based on a number of pests 1024 detected in a crop location.

Various embodiments relate to application suggestions 1040 being automatically implemented by pest treatment material deployment devices. For example, a network-connected cannister containing pesticide may be installed, for instance, on a bough of a tree, to, upon receipt of a control signal from a pest management platform 1010, automatically spray pesticide at the precisely recommended spray time 1040 that is suggested by a phenological model 1012 to be optimal and/or unique for that specific crop location. Treatment material deployment devices may be stationary or plant-associated deployment cannisters, which can be fixably or moveably attached to a tree/plant or to a suitable support located amongst, near, or in association with a given crop location. Similarly, a mobile vehicle (e.g. a drone, a spray rig, an autonomous sprayer, or the like) equipped with a pesticide sprayer and in networked communication with the platform 1010 may be operable to act on instructions related to treatment suggestions for a plurality of crop location, each having location-specific recommendations. For instance, a platform 1010 may recommend 1040 that each of a set of crop locations be addressed in a particular order and/or according to a particular schedule, and these recommendations may be accordingly carried out automatically by a number of vehicles with minimal intervention, maintenance, labour, or time cost to a grower, and/or optimal treatment times at highly granular treatment regimes. Other embodiments relate to the provision of application suggestions that may be indicated to a grower, for instance via a digital platform (e.g. an internet browser-based interface, a smartphone application, or the like). In embodiments related to the latter, the grower may then, for instance, manually apply application suggestions as per the grower's common practices (e.g. a material distribution conduit, a material reservoir associated with the crop location, a tractor or other vehicle-based material distributor, a combination thereof, or the like).

Whether or not pest treatment applications are automatically performed, or suggestions 1040 are precisely followed, pest treatment application data 1042 may be tracked, and/or recorded in or accessed by the pest management platform 1010. For instance, application data 1042 may comprise the volume, type, and/or time (e.g. calendar day, degree day, or the like) related to how, when, and/or how much pest management materials were actually applied. In some embodiments, suggestions 1040 may not be precisely followed if, for instance, a grower has many locations at which to apply pest treatment materials and is unable to perform all applications according to the recommended schedule. In other embodiments, phenological models 1012 may be location-specific (i.e. different for different crop locations), and prescribe application suggestions 1040 based on different criteria, resulting in different crop locations receiving applications on different days. Such data 1042 may be reported or automatically input to the pest management platform, where it may be locally stored or communicated and written to a database, such as an off-site digital data storage component. For instance, a pest treatment material type, amount, date(s), and frequency of application may be stored in a database in association with the crop location in which it was applied for future or external access. In some embodiments, the cost associated with a particular pest treatment material application may be recorded. Similar embodiments may relate to, for instance, an environmental cost associated with pest treatment applications 1042, such as an environmental footprint associated with crop practices employed.

Record management in agriculture may be required by farmers, regulatory bodies, and others. In particular, records of agrochemical inputs are often required by food and environmental safety regulators. Records are also utilized as feedback to diagnose unexpected outcomes related to timings of specific management, as well as for real-time monitoring and implementation of action plans. In some embodiments, information relating to crop treatment applications, such as but not limited to time/date of application, type of application, quantity of application, duration of application, and rate of application, as well as any sensor data or environmental data associated with any application (including before, during, and after application) may be recorded in accessible data storage. In some embodiments, the data recording is organized as plans, recommendations, work orders, and actuals.

FIG. 18 shows an illustrative workflow of such records management activities. The first part, entitled Plan 1810, comprises data relating to expected information for an anticipated event (e.g., anticipated prescription or phenological models relating to pest activity, as modified by the instant subject matter or otherwise) or events such as the detailed information relating to crop treatment material selection and/or dose, and timing of application. In some embodiments, some or all such information may be general information that is intended to be firmed up closer to the event when the timing of optimal treatment conditions is more certain. This planning can for example be the anticipated action and timing relating to the first application for the control codling moth or other pest, or an outline of multiple events covering all periods of concern related to the management of codling moth season long. For example, a phenological model, as modified by the instantly disclosed subject matter or otherwise, the anticipated details of each application in totality, and the fixed and variable costs of each application event, an expected expenditure can be created for the means of budgeting. In some cases, the plan may constitute the suggestions or recommendations as provided by a phenological model, including as implemented in systems and methods hereof; this may include the predictive novel-event system described below.

The second part of the records management activities shown in FIG. 18 in accordance with some embodiments hereof is Recommendation 1820. A recommendation (e.g., crop treatment application prescription) is a firmed-up event with more concrete details related to product selection, dose, and timing based on recent observed or sensed values or those than can be forecasted with additional certainty. In some cases, these are regulated documents need to be issued by a licensed professional and include detailed information related to the factors leading to their decision. Recommendations records may comprise digital records, both or either human and computer readable, that represent suggestions for taking (or not taking) certain treatment activities. Such suggestions may result from analysis of phenological models based on location-specific information, including the novel-event prediction (“Predictor”) and/or verification (“Verifier”)_systems and components described below. For example, information related to anticipated events (e.g., product, dose, timing, localized sensed data, or other acquire data) as well as reasoning (prediction of high crop risk, ROI supportive of action, pest risk) could be generated by the “Predictor” or the “Verifier”.

The third part of the records management activities shown in FIG. 18 in accordance with some embodiments hereof is Work order 1830. Work order components are generally the recognition of receipt and confirmation of the information of the recommended event being scheduled for execution. Such records may include actual work orders provided to those persons controlling crop treatment application systems (e.g., pesticide sprayers, etc.). Such records may include digital representation of such information that may be used, or translated into information that is used, by automated systems to implement application instructions in accordance with such work orders. They may include human readable and computer readable records. In some cases, these are communicated to the treatment application means via an API over a digital communications network. The automated systems may include pest or crop treatment material deployment devices. Work order records may be used for predicting subsequent events that would need to occur beyond recommendations that are delivered but have not yet reached the date they are to be acted upon.

The fourth part of the records management activities shown in FIG. 18 in accordance with some embodiments hereof is Actual 1840. An actual confirmation of execution of a specific work order in both the details related to product, dose, and timing but also specifics related to such things as the confirmed weather at the time of execution, individuals and teams that executed the event, the machinery and/or technique that was used for deployment (irrigation lines, air blast spray, plane). This information is utilized for regulatory reporting and internal budgeting. Historical records, both or either of human readable or computer readable, that show data or information relating to crop treatment may be provided. This can be used as an auditing tool, but also as an input in future assessments or analysis of future time periods in association with a phenological model. For example, information from this step may relates to the feedback that is fed back into the model that correlates with crop outcome. This is important as records from that “actual” part of records management may deviate from a recommendation/work order due to momentaneous constraints such as hardware failure, human error, judgement calls, novel events, or other unforeseen events that impact whether a recommendation or work order was implemented as specified in the records associated therewith. In some embodiments, this such deviations can be used to assess or tune future suggestions based on pre-existing or modified phenological models and location-specific data.

Each of these steps have different purposes, for example plans and work orders may be useful for budgeting and logistics. Whereas recommendations, and actuals directly fulfill regulatory requirements. The ability to fill these reports in a computer aided fashion is particularly significant, as agrochemical inputs can only be used within specific parameters, for example all products have legally specified application rates, and pre-harvest interval. Therefore, ensuring that work orders have legally compliant parameters is clearly important. Pest phenology models as herein utilised are extremely well suited to interact with these workflows. In particular the models and verifier tool can inform both plans and recommendations. In particular they can prescribe application timing and inform product selection. The Actuals 1840 are then collected by our system as an input to develop phenological and ROI models for the next growing season. Records relating to plan, recommendations, work order, and actual records may be stored on and accessible from data storage facilities, including network-accessible storage servers and/or cloud-based storage services. Accordingly, farmers, suppliers, regulators, purchasers, and other authorized persons may access some or all records in accordance with the record-owner preferences via the Internet or other local or wide area network. As such, certain activities, decisions, and requirements can be automatically implemented, including when records formats and/or access thereto are standardized.

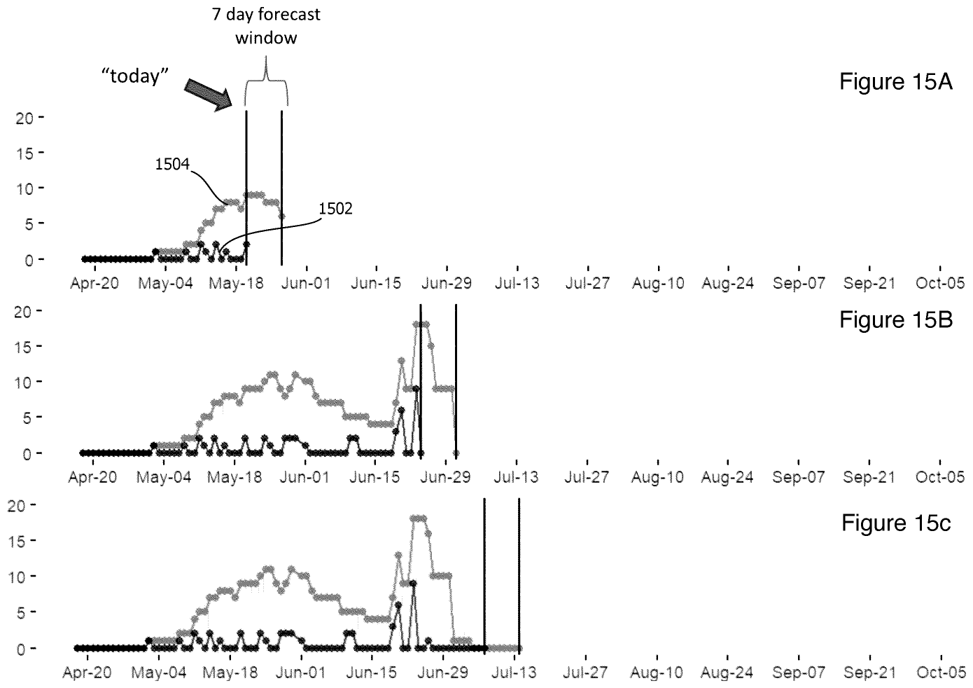

FIGS. 15A to 15C are plots of exemplary pest monitoring data 1502 and pest risk 1504 for an exemplary pest, in this case the codling moth. Monitoring data 1502 is adult codling moth trap captures, while pest risk 1504 is an estimate of the relative abundance of codling moth eggs and young larvae, which are the target life-stage for codling moth management, in accordance with some embodiments.

In accordance with some embodiments, such risk 1504 may be a function of accumulated monitoring data 1502 over a degree day (DD) constant, in this case 150 DD. That is, while, for some embodiments, trap data 1502 may be accumulated over a standard time window (e.g. a rolling sum over 7-day time windows), other embodiments employ a degree day-based model for assessing risk 1504 from accumulated pest data 1502. In accordance with various embodiments, such risk 1504 may be projected to a future time, for instance to help growers plan adequate pest management practices and/or allow for more accurate real-time decisions as to whether previous planned applications would be appropriate in view of real-time data and pest risk predictions.

For some pests, risk decays in relation to temperature. In particular, forecasted risk decays in relation to favourable pest management forecasted temperature. For example, in FIG. 15A, during the spring when temperatures are cooler, the forecasted pest risk 1504 decays slowly in a forward-looking 7-day forecast window. Conversely, and as shown in FIG. 15B, during a heat event in the early summer, the forecasted risk declines dramatically over the 7-day forecast. This information may, for instance, provide an indication that the opportunity to intervene with sprays for the observed population will be over shortly, in accordance with some embodiments. On the other hand, the plot of FIG. 15C shows that the forecasted risk 1504 is null, and that there may be no benefit to management intervention at this time, as the target-life-stages (eggs and young larvae) are not expected to be present. This may be determined from a pest phenology risk model that considers, for instance, that the absence of observed pests 1502 in the days preceding the prediction window, as well as a forecasted temperature, corresponds to an extremely low risk of particularly harmful pest activity.

Crop outcome data from one or more of the crop locations may additionally be observed and/or recorded. For instance, a grower may observe how crops at various crop locations respond to applications of pest treatment materials (e.g. a crop does not experience pest damage, pest hatching does not appear reduced upon treatment, or the like), and input the response in the pest management platform 1010. In some embodiments, sensors may report crop outcome data 1050 (e.g. a dendrometer may report a plant status), which may be input into or automatically communicated via a network to the pest management platform 1010. In accordance with some embodiments, such data 1050 may be reported during crop growth (e.g. pre-harvest).

Alternatively, or additionally, crop outcome data 1050 may comprise post-harvest data. For instance, crop outcome data 1050 may comprise a raw weight of harvested crop, an amount of crop that was lost to pest damage, and/or a net weight of crop harvested that may be sold. In some embodiments, a quality or grade of product may be recorded by a pest management platform 1010. For instance, a crop location may provide a first weight of a top-grade product and a second weight of a low-grade product, each of which may have an associated sale value.

In accordance with various embodiments, any one or more of sensed data 1020, external data 1030, application suggestions 1040, actual pest treatment material application data 1042, or crop outcome data 1050 may be stored in a database associated with the pest management platform 1010 as historical data 1014. The pest management platform 1010, having, for instance, a digital data processor associated therewith, may access historical data 1014 to determine if a correlation 1016 exists between any or all of the stored data 1014. In accordance with various embodiments, a correlation may further relate to a location-specific correlation 1016, such as a location-specific correlation 1016 between a crop outcome 1050 for a particular location and, for instance, a pest treatment application regime 1042 employed for that location. Further, some embodiments relate to tracking any correlations 1016 over time, for instance via storage of correlations 1016 as historical data 1014 for subsequent processing and evaluation.

A correlation 1016 may range, in accordance with various embodiments, from a simple relationship, such as a fitted function to raw values, or a pest treatment material application 1042 resulting in an acceptable yield 1050, to complex relationships analysed by, for instance, an artificial intelligence platform to determine an interplay between multiple input variables and between thousands of crop locations. For instance, and in accordance with at least one embodiment, a pattern recognition algorithm or a neural network may analyse historical data 1014 to determine that a frugal application 1042 of a pesticide at a first crop location resulted in a large yield of low-grade product and a small yield of high-grade product, but at an increased return on investment 1050 as compared to a second crop location that yielded a large degree of high-grade product but was treated at high cost with a large amount of pesticide 1042. In other embodiments, a correlation 1016 may comprise changes to raw sensor values 1020 over time, a comparison of sensor values 1020 at different crop locations, or the like.

Various embodiments relate to various other correlations that may computed. For instance, processing of historical data 1014 may indicate a correlation 1016 that pesticide application 1042 is more optimally performed at a given number of degree days after a threshold number of pests 1024 are detected in a crop location, or within a range of calendar days after a neighbouring grower 1034 reports a flight season of pests. In some embodiments, such as those related to FIGS. 8A and 8B, a correlation 1016 may further indicate a quality of a phenological model 1012. For instance, a particularly poor fit of a model 1012 to pest trap data 1024 may be indicative of incorrect assumptions related to a pest flight, such as the start time of a flight, or a generation length.

In accordance with various embodiments, a pest management platform 1010 may use a correlation 1016 to update 1018 a phenological model. For instance, a grower may treat different crop locations in accordance with staggered application regimens 1042, and observe improved crop outcome 1050 with one or more of the crop locations. For example, a pest management application 1010 may determine the correlation 1016 that a second crop location, having always received pest treatment materials one day after a first crop location, provided a better yield of product than the first location. The platform 1010 may then update 1018 a phenological model 1012 associated with one or more crop locations to provide application suggestions 1040 that are a calendar day later than suggested by the previous model. Accordingly, various embodiments may further relate to a pest management platform 1010 that may track an order in which pest treatment application were performed, and/or comprise subroutines that may suggest to a grower an order in which to apply pest treatments. For instance, and in accordance with at least one embodiment, a platform 1010 may utilise location-specific crop or pest treatment data (e.g. a farm layout, geography, topology, a pest treatment application labour or time requirement, or the like), to suggest a sequence of crop locations for treatments, to provide, for instance, optimally timed pest treatment applications for a particular farm or set of crop locations.

In accordance with some embodiments, a platform 1010 may suggest an optimised route based on grower resources. For example, and in accordance with one embodiment, a particular grower may have access to limited pest treatment deployment devices (e.g. two tractors equipped for pesticide deployment) to apply pest treatment materials across a large area of crops (e.g. hundreds of crop locations across several fields, each crop locations having unique location-specific phenologies). A processor and/or pest management platform 1010 may, in accordance with some embodiments, be operable to compute, in view of all location-specific phenological models associated with the location-specific phenologies, an optimised sequence and/or route for, for example, two tractors to apply pest treatment materials. While each tractor may conventionally be assigned to a treating crop locations in respective fields, a platform 1010 may determine, based on the particular application suggestion 1040 timings for all crop locations, that an optimal route for a first deployment tractor may comprise treating crop locations between different fields, if, for instance, a second deployment tractor may be more optimally used elsewhere at a particular time. In similar embodiments, routes or sequences may be optimised in consideration of balancing time requirements for a deployment device to travel between crop locations to provide location-specific treatments, the fuel costs associated therewith, the potential loss of value of a crop based on a missed time window at the expense of such costs, or the like.

In some embodiments, phenological models 1012 may diverge over time for different crop locations as updates 1018 are performed by a platform 1010 based on, for instance, pest activity associated with the different crop locations. For instance, in a first growing season, a grower may apply the same regional generalised phenological model 1012 and associated application suggestions 1040 to all crop locations on a farm. Upon processing treatment application data 1042 and crop outcome data 1050, the platform 1010 may determine an effectiveness of the first generalised phenological model 1012 and sensed pest trap data 1024 for each of the plurality of crops treated. The platform 1010 may then utilise that correlation 1016, on a site-by-site basis, to update 1018 the model for each location in which pest data 1024 was collected. For instance, while a first crop location may be well characterised by a generalised model 1012 and not be improved by an update 1018, a model 1012 associated with a second crop location may be updated 1018 to modify an expected pest flight start date or generation length, as described, for instance, above with respect to FIG. 8B.

In accordance with some embodiments, sensed data 1022 need not be directly acquired in a crop location(s), but rather in an area associated with the crop location(s). For instance, a weather station on a mountain top or on an adjacent or nearly-adjacent field, farm, or plot, may sense a temperature, humidity, windspeed, or the like, and communicate the environmental data 1022 to a pest management platform 1010. A phenological model 1012 associated with crop locations nearby, or those that have been determined to be correlated 1016 with environmental data 1022 reported by the weather station sensor, may then suggest appropriate pest treatment application times 1040 in view of the representative sensed data. Accordingly, a phenological model 1012 may be associated with large crop areas (e.g. all crops on a farm, all crop locations on the Western border of the farm, etc.).

In accordance with various other embodiments, a location-specific phenological model 1012 may relate to hyper-specific crop locations. For instance, phenological models 1012 may differ for different regions and/or strata of a tree canopy, such as if, for example, analysis of historical data indicated that certain areas of the tree are rarely exposed to pests and any application to such areas may be unnecessary.

An exemplary pest phenology framework for outputting predictive pest phenology models that are updated over time and responsive to in-field pest phenology observations, generally described by the numeral 1100, will now be described with reference to FIG. 11. In this example, a pest phenology framework 1100 may receive few inputs to output predictive models and reports. For example, and in accordance with some embodiments, one or more of environmental data 1110, such as a temperature or weather station data, may be input into a predictive pest model 1120 to provide a degree day prediction of a pest flight. In some embodiments, a phenology model 1120 may be a regional model or a location-specific model as described above (e.g. farm-, block, crop-level, or the like). In some embodiments, network data 1112, or third-party data 1112 (e.g. external weather stations, aerial imagery, etc.) may additionally or alternatively serve as input for models to generate predictions. In some embodiments, sensed data, such as pest trap or other monitored data 1114 may, for instance, keep a model 1120 up to date. Based on the predictive pest model 1120 and particular use cases, the platform 1100 may output reports 1130 on monitored or other input data, and may further provide reports on predicted pest behaviour 1132 (e.g. a predicted future monitoring report).

A pest phenology framework 1100 may further comprise models that provide predictions and suggested crop management actions that are related to crop outcomes, such as yield, or return on investment. For instance, a decision outcome model or database 1122 may receive as input reported crop data 1140, such as crop outcome data as described above, intervention data 1142 (e.g. pest treatment material application volumes, times, schedules, or the like), as well as external intervention data 1144 related to other crop locations, such as neighbouring or other crop location pest material application data, crop outcomes related thereto, or the like. In accordance with some embodiments, the platform 1100 may allow for iteration 1124 of models 1120 and 1122 based on input data. For instance, iteration 1124 of models 1120 and 1122 may be performed upon input of historical data, current pest monitoring data 1114, environmental data 1110, or the like, to, for instance, optimise models in view of crop outcomes 1140 and intervention data 1142 and 1144, and thereby provide crop management suggestions that may optimise a return on investment. The platform 1100 may further output various reports and predictions for user consumption and/or feedback to improve models 1120 and 1122, such as regional or location-specific reports 1150 of historical intervention practices, crop yields, and/or crop grades.

The platform 1100 may further report on or otherwise perform predictions 1152 related to intervention practices. For instance, a platform output may comprise a damage or yield loss prediction 1152 based on a grower taking no action with respect to a predicted or monitored pest event. Alternatively, or additionally, the platform 1100 may provide a prediction 1152 of an optimal pest intervention window for crop treatment material application, or report on a predicted optimal intervention regime 1152 that may, for instance, provide the best predicted return on investment. The platform 1100 may further, based on predicted phenology and prescribed goals, automatically control 1154 a recommended intervention action. For instance, the platform 1100 may output a control signal to automatic pest treatment material deployment devices to apply a recommended intervention and optimal timing schedule thereof based on input data and model output.

A framework 1100, in accordance with various embodiments, may deliver to growers site-specific based management recommendations on both historical- and model-predicted ROI performance of specific relevant management interventions related to specific pests and/or management areas. Management practices may include, but are not limited to, scouting, chemical or biological applications (e.g. pesticide or pheromone selection, application timing and/or rate, or spatial release points of chemi- or bio-control agents), mechanical practices (e.g. tillage, mass trapping, or the like), cultural control (e.g. crop residue destruction), or inaction (e.g. the framework determines that management intervention is not warranted at a specific time based on a predicted ROI).

ROI-informed recommendations may be formulated by processing, for instance, on-site climate data from weather stations and/or sensors, automated pest traps or other sensed data, as well as intervention history (e.g. past product selection, product application rates, product timings, damage assessments, quality ratings, harvest timings, or the like) to train location-specific prediction models for pest management. In some embodiments, predictive impacts of each decision option may be weighed against economic metrics, such as cost of suggested products, cost of labour related to intervention implementation, or the value of mitigated crop loss. Recommendations may be further be formulated in an iterative process (re-training or updating 1124 models 1120 and 1122), and/or models may be incremented based on a crop production cycle or the biology of a given pest.

Furthermore, and in accordance with some embodiments, models may employ a frameshifting or weighted schema to focus model training on data that is most relevant to current and/or predicted conditions. For instance, models may be updated according to a frameshifting framework to include only data from a designated past number of years (e.g. only the most recent three years), or according to a framework in which datasets are weighted based on historically similar increments with regard to current or predicted climate and/or biological conditions.

In some embodiments, a framework 1100 may provide to multiple (e.g. tens to thousands) growers hyper-specific crop management recommendations for a given pest(s) in parallel, for instance by prescribing varying ROI-based intervention recommendations tailored to individual growers. Further, a platform 1100 may be employed in parallel for several different pests within the same management area, prescribing, for instance, individual ROI-based recommendations for each pest and crop location, or synergistically providing holistic management recommendations for an efficient simultaneous management program.

In accordance with various embodiments, pest management recommendations may be provided to a grower in a multimedia format that may be delivered via, for instance, email, text, or fax. Some embodiments relate to the provision of pest treatment suggestions via a web and/or mobile application. Accordingly, growers may be provided recommendations in a manner in which they may interact with the recommendation, for instance to simulate sub-optimal ROI impacts of, for instance, altering the timing of a recommendation. For example, a grower subject to logistical constraints (e.g. a grower may only provide pest treatment materials to a maximum number of crop locations in a given day, or within a range of days) may explore the predicted outcomes of actions taken at various times.

Similarly, other actions and/or management practices, such as fertilisation, fertigation, crop irrigation, and the like, may be improved by a framework 1100 to deliver, for instance, ROI-informed decisions based on climate and/or third-party data, soil moisture or dendrometer readings, and/or iteratively improved location-specific crop-related models, in accordance with various embodiments.

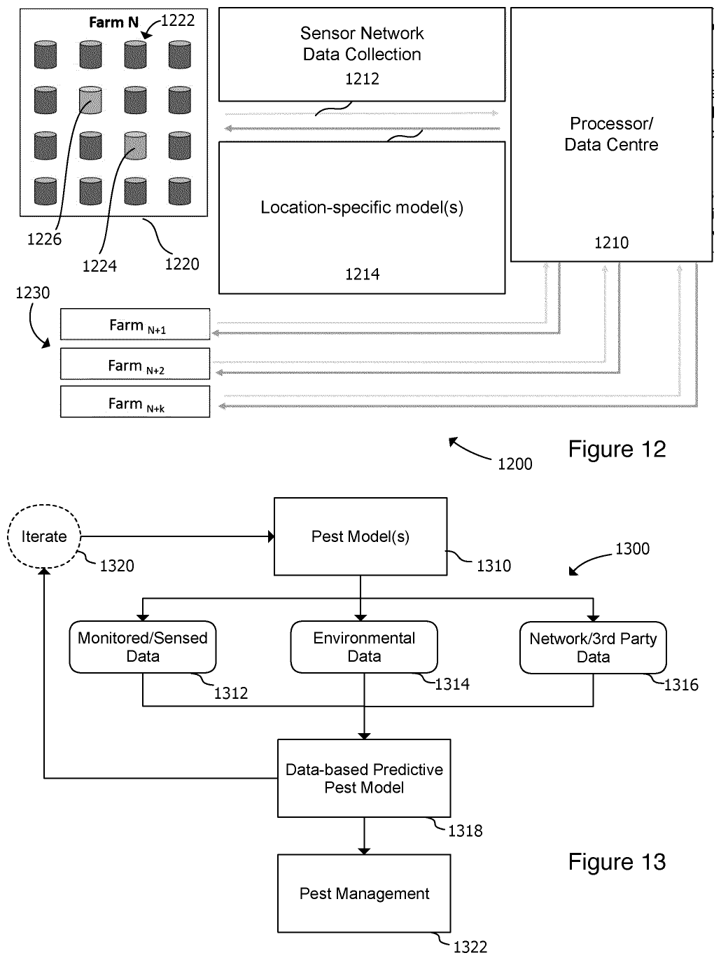

With reference now to FIG. 12, and in accordance with various embodiments, an exemplary process for collecting data to make informed farm-level crop management decisions, generally referred to with the numeral 1200, will now be described. In this example, a data processor 1210 may receive sensed data 1212 from, for instance, a farm 1220 having a plurality of network-interfacing sensors, shown by cylinders 1222 in FIG. 12. Such sensors may comprise, for instance, wireless connectivity, and/or form an on-farm sensor network 1222. Sensors may comprise, for instance, a weather station 1224, one or more insect traps 1226, and/or temperature sensors. Data 1212 collected may then be sent to or received by a processor or data centre associated with a crop management platform 1210, which may have associated therewith one or more phenological models, which may, in some embodiments, be farm-specific. The processor 1210 may develop or improve farm-specific models using farm-specific data 1212. Such phenological models may be developed iteratively, for instance by adding newly acquired data 1212 and recalculating models in increments relevant to a crop production cycle (e.g. yearly for apples), and/or a pest biology or phenology (e.g. between pest generations). A location-specific phenological pest model 1214, such as model 1214 that is specific to a particular farm (e.g. Farm N 1220), may then be pushed or sent to, for instance, the farm's pest manager via a web interface, in addition to, for instance, standardised reports related thereto. Further, the location-specific phenological pest model 1214 may further be automatically applied to produce automatic pest treatment material applications at any locations adequately equipped to that end (e.g. spraying a pesticide on any crop block, crop row, or the like, having an automatic pest material sprayer). This process may be conducted in parallel across many farms 1230, and/or multiple crops (e.g. for different crop locations on the same farm), for different pest combinations, or the like.

Furthermore, non-networked crop locations may benefit from similar embodiments. For instance, non-networked areas (e.g. a neighbouring farm), or a crop location that does not comprise a particular sensor type whose data may be recommended for a particular pest model 1214, may assume, for instance, neighbouring crop location values for a sensed parameter (i.e. a parameter may be substituted for one from an associated crop location). Such embodiments may be employed if, for instance, the farm 1220 has only one crop location with a pest trap 1226. In some embodiments, pest data collected at location 1226 may be assumed to be representative of other locations 1222 on farm 1220. Conversely, if a crop location such as a farm does not have access to, for instance, a temperature sensor in networked communication, a nearby weather station (e.g. on a hill side kilometers away from the crop and not physically located on the farm itself), may provide, for instance, climate data representative for one or more locations on the farm.

While FIG. 12 schematically illustrates the collection of environmental data (e.g. weather station data 1224) as separate from crop location-specific sensed data (e.g. pest trap data 1226), the scope of the disclosure is not to be understood as so limited. For instance, and in accordance with some embodiments, a measurement of a temperature (i.e. sensed data) may be used by a pest model as readily as sensed pest trap data, while the latter may not be required for some models and/or embodiments. Further, various forms of sensed data may be relevant to different spatial and/or temporal scales. For instance, different pests may exhibit damage, be relevant to crops, or otherwise operate at different scales, and interact with plant phenology in different ways (e.g. hull split). Various embodiments therefore relate to the collection of large datasets across multiple scales to package relevant scale-specific models, recommendations, suggestions, and the like, for different geographical scales (e.g. farm-level, region-level, plant level, and the like).

With reference now to FIG. 13, an exemplary process for phenological pest modeling, generally referred to with the numeral 1300, will now be described, in accordance with various embodiments. In this example, a pest model 1310, which may be associated with, for instance, the processor 1210 of FIG. 12, situated on-site at a farm, or generally otherwise associated with a pest management platform, may comprise terms and/or modules related to, for instance, monitored or sensed data 1312 (e.g. temporal and/or spatial pest distribution data collected via wirelessly networked automated insect traps), environmental data 1314 (e.g. temperature, humidity, rainfall, wind direction data, or the like, for instance collected via an array of wirelessly networked sensors), and/or third-party or otherwise network-accessible data 1316 (e.g. crop management data such as pesticide application records and associated crop outcomes as reported by third parties). Upon sensing or acquiring data 1312, 1314, and/or 1316, the pest model 1310 may be populated and/or calculated to provide a data-based predictive pest model 1318. Predictive models may be, for instance, iteratively fed back into or accessed by a pest management platform to iteratively update a pest model 1310, for instance to provide location-specific models for future use and/or iteration upon the acquisition of new data 1312, 1314, and/or 1316. The farm- or crop location-specific predictive phenological pest model 1318 may then be applied or processed by, for instance, a farm and/or pest manager 1322 at, for instance, appropriate intervals relevant to the crop location being monitored.

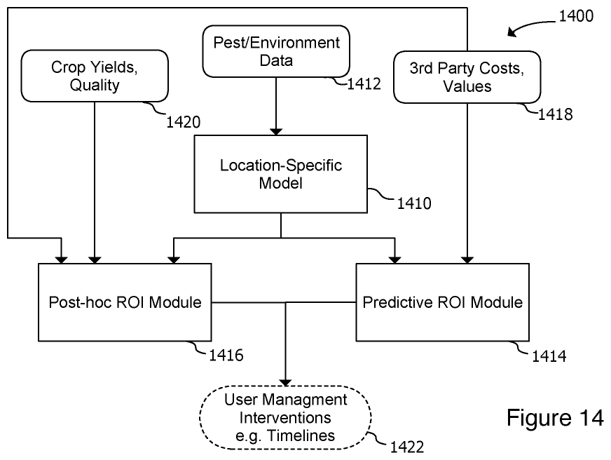

With reference now to FIG. 14, and in accordance with various embodiments, an exemplary process for providing ROI-informed crop management suggestions, generally referred to with the numeral 1400, will now be described. In this example, location-specific crop models 1410 developed by a crop management platform may be used to predict location-specific (e.g. farm-specific) activity of a modelled pest relative to local environmental conditions 1412. The model 1410 may provide, for instance, timelines for pest management interventions 1422 based on the presence of susceptible stages of the modelled pest. Intervention suggestions may comprise, for instance, optimal windows of time to apply a pesticide, supplemental monitoring of a crop area, implementations of farm sanitisation, or other pest management practices relevant to the modelled pest.

A pest model 1410 may, in accordance with various embodiments, comprise predictive ROI modules 1414 and/or post-hoc ROI modules 1416. A predictive ROI module 1414 may in turn comprise or output, for instance, insights related to the ROI of management interventions, in real-time to allow a user to adjust management practices as necessary. For example, a predictive module 1414 may display to a user a diminishing return of a management intervention suggestion applied outside of an optimal intervention window, wherein the determination is based on, for instance, third-party data 1418 related to costs of management interventions and commodity values (e.g. a value related to crop grades expected based on management interventions). Conversely, a predictive ROI module 1414 may display a favourable ROI for intervention practices performed in time windows when susceptible pest stages are present (e.g. a hatching season predicted from pest and/or environmental data 1412). ROI estimates may, for instance, be adjusted based on the cost of management interventions and/or crop values.

A post-hoc ROI module 1416 may in turn incorporate, for instance, third-party data and/or grower-provided yield and crop quality data 1420 to assess ROI of management intervention practices after, for instance the end of a growing season. Such a module 1416 of a location-specific model 1410 may provide a user with, for instance, a retrospective assessment of their pest management program relative to an observed crop yield and/or quality, or a location-specific pest phenology. Further, modules 1414 and 1416 of a crop location-specific model 1410 or pest management platform may allow users to determine the value of particular management interventions based on a newest or updated phenological model 1410.

Intervention data 1422 provided to a user may in turn comprise, for instance, explicit management intervention timelines (e.g. when to spray a crop or crop location with a pesticide), a real-time predictive ROI for upcoming management interventions, a retrospective post-hoc ROI for evaluation of the effectiveness of a pest management program, or the like.

In some embodiments, there are provided novel event pest analysis prediction systems or components. In general, predictive phenological models use historical data to generate phenological models that will predict the occurrence of pests at a site-specific level. These models can be used to predict periods of time in which pest activity is expected to occur, including in real-time or near real-time (e.g. in the upcoming 5 to 10 days, or in the upcoming 2 to 3 days, or in the upcoming 10 to 48 hours). These models can be used to plan a pest management program (e.g., budgeting and logistics), and/or to directly implement a pest management program (e.g., apply a crop application material routine, e.g. a cover spray, between 400 to 1000 degree-days at a specific location). In some embodiments, some predictive models based on pre-existing and often season-based phenological models may be updated once yearly, according to the growing season in a particular region (for example in December in the northern hemisphere, or June in the southern hemisphere) and which may, in some embodiments be corrected on a location-specific basis. For example, in 2021 a neighbour's newly planted block came into 1st year production, thereby changing pest dynamics on the orchards border. Therefore, a phenology model built using data up to 2020 may or may not accurately predict such novel dynamics in 2021. Furthermore, these models cannot account for fine scale stochastic variation, for example, extreme weather events such as a heat wave, prolonged rain, that may disrupt typical patterns of pest phenological. However, these predictive models can be complemented and enhanced by verifying the pest risk derived from pest monitoring data in the 7 days leading up to any management intervention (e.g. spraying a pesticide). For example, with respect to FIG. 15A, shows a calculated pest risk 1504 both historically and into the future by 7 days, wherein actual pest activity 1052 in connection, in some embodiments, with current and forecasted weather information (or, depending on the embodiment, other sensed or acquired data) is used to calculate such 7-day window prediction. Such predictive information that may be location specific and which is based on very recent or current actual events, as well as more accurate short-term novel event predictions (e.g., tomorrow's weather as opposed to a seasonal event predicted before or early in the growing season) can be used to provide stand-alone suggestions. For example, in FIG. 15A, the pest risk is predicted to remain high and suggests immediate crop treatment. FIG. 15B suggests that pest risk, although currently high, will drop and therefore no crop treatment should be applied. FIG. 15C suggests almost no pest risk and therefore no crop treatment should occur. Conversely, these can be used to confirm or influence (i.e. verify) existing suggestions, which will be described in further detail below. Accordingly, phenological models can be adjusted or improved, or in some cases replaced, by utilizing real-time or near-real-time sensed and/or environmental data, applicable in many embodiments on a location-specific bases. The novel predictive pest analysis system or component therefore utilizes near term information within the current growing season or crop growth phase (e.g., the past days, week or month) to account for novel or unexpected events that may influence or in some cases replace crop treatment suggestions that are based on more long term phenological models that are generally based on prior growing seasons.

In some embodiments, there is provided a recommendations verifier system or component that uses in-season pest monitoring data, in conjunction with current and forecasted environmental data to generate an instantaneous prediction of pest risk, which can be used to verify or create management recommendations. Pest risk may be calculated by accumulating pest monitoring data over physiological time rather than calendar time; such risk is also often calculated at each sensor location, as shown in FIG. 17, and may therefore be location-specific. Most agricultural pests (arthropods, nematodes, weeds, pathogens) are ectotherms, meaning they don't generate their own body heat, as such their physiological development can be modelled in respect to temperature (physiological time, measured in degree-days) rather than calendar time (measured in days, hours, etc.) Trapping data is accumulated over physiological time, using a degree-day constant that is unique to the specific life-stage(s) of the pest to be managed (e.g. 150 DD for codling moth eggs and young larvae). This degree-day constant may also be unique to specific pest-host combinations; for example, oriental fruit moth develops at different rates on pome fruit and stone fruit. The degree-day constant may also be unique for specific pest-‘host-life-stage’ combinations. For example, Lobesia, a pest of grapes, develops slower when feeding on vegetative plant tissue, compared to feeding on ripening berries, which it prefers and is only present in the later part of the growing season. Pest risk can then be forecasted using recent or actual weather predictions in connection with trap data or other pest-sensing data. In an exemplary case, the forecasted pest risk may indicate that a population of the target pest-life-stage will change over the next 7 days; this may be because a recent event, such as a weather event like a drop in temperature or increase in precipitation, possibly but not necessary in connection with sensed pest data may indicate that there is a likelihood that pest activity will change. This may or may not necessarily coincide with crop treatment applications that have been developed using historical phenological models in accordance with various embodiments hereof. Accordingly, the verifier may be used in some embodiments to adjust or amend the recommendations (e.g., the population of a pest is low and is expected to stay low for the next 7 days and so a planned crop treatment application in respect of that pest should be cancelled or deferred). Steep declines in forecasted risk indicate that the target pest is developing quickly and the opportunity to intervene will end soon. Shallower declines indicate that the pest is developing more slowly, and management interventions are less time sensitive. For example, once the pest risk reaches zero, there is no benefit to spraying as we would predict none of the target pest-life-stage to be present at that time. In some embodiments, the verifier utilizes one or more of sensed pest and environmental data, novel and/or short-term phenological models (e.g., moth larva growth at specific temperatures) that may or may not be the same as the phenological model used for developing suggestions, to amend existing suggestions or make new suggestions. In cases where sensed data contributes to the verifier, the amending or replacement of the suggestions may be affected in a location-specific manner. In some cases, the new or modified suggestions are considered when modifying existing or prior used phenological models that are used for developing suggestions in future growing seasons or phases.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. A pest management system for managing application of pest treatment materials to one or more crop locations based on a phenological model, the system comprising:
one or more network-interfacing sensors configured to acquire and communicate sensed data associated with the one or more crop locations;
a digital data storage component for storing, over time, in association with the one or more crop locations:
said sensed data;
pest treatment application data for pest treatments applied in connection with one or more pest treatment application suggestions;
crop outcome data; and
the phenological model for the one or more crop locations that provides the one or more pest treatment application suggestions in connection with said sensed data; and
a digital data processor in network communication with said digital data storage component and operable to calculate a correlation between said crop outcome data and said pest treatment application data for the one or more crop locations.

2. The pest management system of claim 1, wherein the one or more crop locations comprise the location of one or more of a farm, a field, a crop area, a portion of a field, a block, a portion of a block, a row of plants, a portion of a row of plants, a group of plants, a plant, and a portion of a plant.

3. The pest management system of either one of claim 1 or claim 2, wherein said digital data processor is further configured to modify said pest treatment application suggestions in the phenological model for at least some of the one or more crop locations based on said correlation.

4. The pest management system of claim 3, wherein said digital data processor is further configured to modify the phenological model by replacing at least some of said pest treatment application suggestions for at least some of the one or more crop locations.

5. The pest management system of any one of claims 1 to 4, wherein at least some of said sensed data comprises at least one of environmental data, insect monitoring data, weed monitoring data, a crop stage, and observational data.

6. The pest management system of any one of claims 1 to 5, wherein at least some of said crop outcome data comprises observational crop data.

7. The pest management system of claim 6, wherein said observational crop data comprises at least one of pre-harvest crop data and post-harvest crop data.

8. The pest management system of any one of claims 1 to 7, wherein at least some of said crop outcome data relates to at least one of a yield, a grade, and a crop damage.

9. The pest management system of any one of claims 1 to 8, wherein at least some of said crop outcome data comprises sensed crop data.

10. The pest management system of any one of claims 1 to 9, wherein at least some of said crop outcome data is indicative of crop value.

11. The pest management system of any one of claims 1 to 10, further comprising:
one or more pest treatment deployment devices configured to apply the pest treatment materials in response to a control signal generated in response to said pest treatment application suggestions.

12. The pest management system of claim 11, wherein said one or more pest treatment deployment devices are further configured to selectively apply the pest treatment materials at specific locations of the one or more crop locations in response to said control signal.

13. The pest management system of either one of claim 11 or claim 12, wherein said pest treatment deployment devices are configured to release the pest management materials from one of a material distribution conduit, a distributed material reservoir, a vehicle-based material distributor, and a combination thereof.

14. The pest management system of any one of claims 1 to 13, wherein said digital data storage component stores pest treatment material data in association with each of said pest treatment application data, said pest treatment material data comprising at least one of a volume, a type, or a concentration of the pest treatment materials.

15. The pest management system of claim 14, wherein said digital data processor is further operable to determine a value correlation between said crop outcome data and said pest treatment material data for each of the one or more crop locations.

16. A pest management method for managing the application of pest management materials to one or more crop locations based on a phenological model stored on a digital data storage component, the phenological model for providing pest treatment application suggestions in association with sensed data, the method comprising:
acquiring, by one or more network-interfacing sensors, sensed data associated with the one or more crop locations;
communicating said sensed data to the digital data storage component;
storing on said digital data storage component, over time and in association with the one or more crop locations, said sensed data, pest treatment application data for pest treatments applied in connection with one or more pest treatment application suggestions, and crop outcome data;
calculating, via a digital data processor in network communication with said digital data storage component, a correlation between said crop outcome data and said pest treatment application data in association with the one or more crop locations.

17. The pest management method of claim 16, wherein the one or more crop locations comprise the location of one or more of a farm, a field, a crop area, a portion of a field, a block, a portion of a block, a row of plants, a portion of a row of plants, a group of plants, a plant, and a portion of a plant.

18. The pest management method of either one of claim 16 or claim 17, further comprising:
modifying the phenological model by adjusting said pest treatment application suggestions based on said correlation.

19. The pest management of method claim 18, further comprising:
modifying the phenological model by replacing at least some of said pest treatment application suggestions with corresponding modified pest treatment application suggestions.

20. The pest management method of any one of claims 16 to 19, wherein said acquiring sensed data associated with the one or more crop locations comprises acquiring at least one of environmental data, insect monitoring data, weed monitoring data, a crop stage, and observational data.

21. The pest management method of any one of claims 16 to 20, wherein at least some of said crop outcome data comprises observational crop data.

22. The pest management method of claim 21, wherein at least some of said observational data comprises at least one of pre-harvest crop data and post-harvest crop data.

23. The pest management method of any one of claims 16 to 22, wherein at least some of said crop outcome data comprises relates to at least one of a yield, a grade, and a crop damage.

24. The pest management method of any one of claims 16 to 23, wherein at least some of said crop outcome data is indicative of crop value.

25. The pest management method of any one of claims 16 to 24, further comprising:
generating a control signal in response to said pest treatment application suggestions;
upon receipt of said control signal, applying via one or more pest treatment deployment devices the pest treatment materials.

26. The pest management method of claim 25, wherein said applying comprises selectively applying the pest treatment materials at specific locations of the one or more crop locations in response to said control signal.

27. The pest management method of either one of claim 25 or claim 26, wherein said applying comprises releasing the pest management materials from one of a material distribution conduit, a distributed material reservoir, a vehicle-based material distributor, and a combination thereof.

28. The pest management method of any one of claims 16 to 27, further comprising storing pest treatment material data in association with each said pest treatment application time, wherein said pest treatment material data comprises at least one of a volume, a type, or a concentration of the pest treatment materials.

29. The pest management method of claim 28, comprising calculating a value correlation between said crop outcome data and said pest treatment material data for each of the one or more crop locations.

30. A pest management device for managing the application of pest management materials to one or more crop locations based on a phenological model, the system comprising:
a network communications bus for accessing one or more network-interfacing sensors configured to acquire and communicate sensed data associated with the one more crop locations;
a data storage component for storing, over time and in association with the one or more crop locations:
said sensed data;
pest treatment application data for pest treatments applied in connection with one or more pest treatment application suggestions;
crop outcome data; and
the phenological model providing pest treatment application suggestions in connection with said sensed data; and
a digital data processor in network communication with said digital data storage component and operable to calculate a correlation between said crop outcome data and pest treatment application data for the one or more crop locations.

31. The pest management device of claim 30, wherein the one or more crop locations comprise the location of one or more of a farm, a field, a crop area, a portion of a field, a block, a portion of a block, a row of plants, a portion of a row of plants, a group of plants, a plant, and a portion of a plant.

32. The pest management device of either one of claim 30 or claim 31, wherein said digital data processor is further configured to modify said pest treatment application suggestions in the phenological model for at least some of the one or more crop locations based on said correlation.

33. The pest management device of claim 32, wherein said digital data processor is further configured to modify the phenological model by replacing at least some of said pest treatment application suggestions with corresponding modified pest treatment application suggestions for at least some of the one or more crop locations.

34. The pest management device of any one of claims 30 to 33, wherein at least some of said sensed data comprises at least one of environmental data, insect monitoring data, weed monitoring data, a crop stage, and observational data.

35. The pest management device of any one of claims 30 to 34, wherein at least some of said crop outcome data comprises observational crop data.

36. The pest management device of claim 35, wherein said observational crop data comprises at least one of pre-harvest crop data and post-harvest crop data.

37. The pest management device of any one of claims 30 to 36, wherein at least some of said crop outcome data relates to at least one of a yield, a grade, and a crop damage.

38. The pest management device of any one of claims 30 to 37, wherein at least some of said crop outcome data comprises sensed crop data.

39. The pest management device of any one of claims 30 to 38, wherein at least some of said crop outcome data is indicative of crop value.

40. The pest management device of any one of claims 30 to 39, wherein said network communications bus is further operable to communicate with one or more pest treatment deployment devices configured to apply the pest treatment materials in response to a control signal generated in response to said pest treatment application suggestions.

41. The pest management device of claim 40, wherein said network communications bus is further operable to communicate with said one or more pest treatment deployment devices so to selectively apply the pest treatment materials at specific locations of the one or more crop locations in response to said control signal.

42. The pest management device of any one of claims 30 to 41, wherein said digital data storage component stores pest treatment material data in association with each of said pest treatment application data, said pest treatment material data comprising at least one of a volume, a type, or a concentration of the pest treatment materials.

43. The pest management device of claim 42, wherein said digital data processor is further operable to determine a value correlation between said crop outcome data and said pest treatment material data for each of the one or more crop locations.

44. A crop growth management system for managing application of crop treatment materials to one or more crop locations based on a phenological model, the system comprising:
one or more network-interfacing sensors configured to acquire and communicate sensed data associated with the one or more crop locations;
a digital data storage component for storing, over time and in association with the one or more crop locations:
the sensed data;
crop treatment application data for crop treatments applied in connection with one or more crop treatment application suggestions;
crop outcome data related to a crop value; and
the phenological model providing the one or more crop treatment application suggestions for the crop treatment material in connection with said sensed data; and
a digital data processor in network communication with said digital data storage component and operable to calculate a correlation between said crop outcome data and said crop treatment application data for the one or more crop locations.

45. The crop growth management system of claim 44, wherein the one or more crop locations comprise the location of one or more of a farm, a field, a crop area, a portion of a field, a block, a portion of a block, a row of plants, a portion of a row of plants, a group of plants, a plant, and a portion of a plant.

46. The crop growth management system of either one of claim 44 or claim 45, wherein said digital data processor is further configured to modify said crop treatment application suggestions in the phenological model for at least some of the one or more crop locations based on said correlation.

47. The crop growth management system of claim 46, wherein said digital data processor is further configured to modify the phenological model by replacing at least some of said crop treatment application suggestions with corresponding modified crop treatment application suggestions for at least some of the one or more crop locations.

48. The crop growth management system of any one of claims 44 to 47, wherein at least some of said sensed data comprises at least one of environmental data, insect monitoring data, weed monitoring data, a crop stage, crop nutrient data, soil moisture data, and observational data.

49. The crop growth management system of any one of claims 44 to 48, wherein at least some of said crop outcome data comprises observational crop data.

50. The crop growth management system of claim 49, wherein said observational crop data comprises at least one of pre-harvest crop data and post-harvest crop data.

51. The crop growth management system of any one of claims 44 to 50, wherein at least some of said crop outcome data relates to at least one of a yield, a grade, and a crop damage.

52. The crop growth management system of any one of claims 44 to 51, wherein at least some of said crop outcome data comprises sensed crop data.

53. The crop growth management system of any one of claims 44 to 52, wherein at least some of said crop outcome data is indicative a net value of a crop.

54. The crop growth management system of any one of claims 44 to 53, further comprising:
one or more crop treatment deployment devices operable configured to apply the crop treatment materials in response to a control signal generated in response to said crop treatment application suggestions.

55. The crop growth management system of claim 54, wherein said one or more crop treatment deployment devices are further configured to selectively apply the crop treatment materials at specific locations of the one or more crop locations in response to said control signal.

56. The crop growth management system of either one of claim 54 or claim 55, wherein said crop treatment deployment devices are configured to release the crop treatment materials from one of a material distribution conduit, a distributed material reservoir, a vehicle-based material distributor, and a combination thereof.

57. The crop growth management system of any one of claims 44 to 56, wherein said digital data storage component stores crop treatment material data in association with each of said pest treatment application data, said pest treatment material data comprising at least one of a volume, a type, or a concentration of the pest treatment materials.

58. The crop growth management system of claim 57, wherein said digital data processor is further operable to determine a value correlation between said crop outcome data and said crop treatment material data for each of the one or more crop locations.
